(19) United States
(12) Patent Application Publication
(10) Pub. No.: US 2016/0110690 A1
(43) Pub. Date: Apr. 21, 2016

(54) USER EXPERIENCE FOR CAPTURING TIMESHEET ITEMS

(71) Applicant: Microsoft Technology Licensing, LLC, Redmond, WA (US)

(72) Inventors: Kyle S. Young, Duval, WA (US); Lisa R. Mueller, Seattle, WA (US); Julianne Prekaski, Redmond, WA (US); Bishara S. Kharoufeh, Redmond, WA (US)

(21) Appl. No.: 14/980,319

(22) Filed: Dec. 28, 2015

Related U.S. Application Data
(63) Continuation of application No. 14/021,843, filed on Sep. 9, 2013.
(60) Provisional application No. 61/835,124, filed on Jun. 14, 2013.

(51) Int. Cl. G06Q 10/10

(52) U.S. Cl. CPC G06Q 10/1091

(57) ABSTRACT

A management component in a computer system provides user input mechanisms that allow a user to capture time entries on a timesheet in the computer system. The items in a given timesheet can be separately viewed and edited and the timesheet can be submitted for approval.

### CROSS-REFERENCE TO RELATED APPLICATION(S)

The present application is a continuation of and claims priority of U.S. patent application Ser. No. 14/021,843, filed Sep. 9, 2013, which is based on and claims the benefit of U.S. provisional patent application Ser. No. 61/835,124, filed Jun. 14, 2013, the contents of which are hereby incorporated by reference in their entirety.

### BACKGROUND

Computer systems are currently in wide use. Many computer systems have items that must be captured, tracked, manipulated, and approved.

As examples, computer systems include business systems, such as enterprise resource planning (ERP) systems, customer relations management (CRM) systems, line-of-business (LOB) systems, etc. These systems often have users capture, submit, approve, track and otherwise manipulate business data or business documents. This can be difficult.

For instance, workers in business systems are often asked to fill out timecards or timesheets and even enter them into workflow so that they can be approved or rejected and, if approved, billed against various projects.

Also, the mobile nature of many businesses makes these tasks even more difficult. For instance, many employees that submit or approve timesheets or other documents travel a great deal or work from remote locations using mobile devices. This can exacerbate the problem of accurately capturing time entries on a timesheet, and then later viewing, manipulating and submitting the timesheet for approval.

The discussion above is merely provided for general background information and is not intended to be used as an aid in determining the scope of the claimed subject matter.

### SUMMARY

A management component in a computer system provides user input mechanisms that allow a user to capture time entries on a timesheet in the computer system. The items on a given timesheet can be separately viewed and edited, and the timesheet can be submitted to a workflow for approval.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system architecture.

FIG. 1A is a more detailed block diagram of an expense management component.

FIG. 1B is a flow diagram illustrating one embodiment of the operation of the expense management component shown in FIG. 1A.

FIGS. 1B-1 to 1E-1 are illustrative user interface displays.

FIG. 1F is a flow diagram showing one embodiment of the operation of the expense management component in capturing and reconciling an expense item.

FIGS. 1F-1 to 1G are illustrative user interface displays.

FIG. 2 is a more detailed block diagram of a timesheet management component.

FIG. 2A is a flow diagram illustrating one embodiment of the operation of the timesheet management component shown in FIG. 2.

FIGS. 2B-2G are illustrative user interface displays.

FIG. 3 is a more detailed block diagram of an approval component.

FIG. 3A is a flow diagram illustrating one embodiment of the operation of the approval component shown in FIG. 3.

FIGS. 3B-3M are illustrative user interface displays.

FIG. 4 shows the architecture of FIG. 1 deployed in various other architectures.

FIGS. 5-10 show illustrative mobile devices.

FIG. 11 is a block diagram of one embodiment of a computing environment.

### DETAILED DESCRIPTION

Before describing capturing and manipulating time entries in more detail, a brief overview is provided for the sake of clarity. In addition, it will be noted that a discussion of manipulating expense reports, and approving business documents is also provided for the sake of completeness, although it will be noted that the invention is not limited to these embodiments.

By way of overview, a phone-based timesheet capture application is linked to a business system, such as an on-premise or cloud-based version of an ERP system, a CRM system an LOB system, etc. The phone-based application automatically generates views based on a time period that is set in the business system. For instance, if the timesheet period is set to one week within the business system, then the phone-based application displays calendar views for one week at a time.

A main timesheet page in the phone-based application allows the user to create a new time entry, review a timesheet for a current period, review timesheets for one or more previous periods, and review time entries by project. The current period view can be a calendar view that allows the user to use touch gestures to make time entries within the calendar view. When the user selects a spot in the calendar view to make a time entry, a details pane allows the user to enter details for that time entry (such as the project identifier, a category code, an activity code, the amount of time to be entered, etc.). When the user clicks save, the time entry is automatically saved, directly from the phone-based application, into a timesheet in the business system. The phone-based application can provide other views as well, such as a summary view, and a view that allows the user to see a breakdown of time entries by day, or by project.

Another user experience (on a mobile device on the laptop, a desktop, a tablet, etc.) includes a timesheet capture application that provides an initial view that provides a summary of the number of timesheets in review and a chart showing the amount of time entries for previous timesheet periods (e.g., for previous weeks). When the user pans the view to the right, the user can see a view of timesheets grouped by state (e.g., timesheets that are in draft form, timesheets that have been rejected, timesheets that have been approved, etc.). One icon or tile is displayed for each timesheet in each group. The user can switch this view to having the timesheets arranged by date, instead of grouped by state.

When the user actuates the icon or tile associated with a given timesheet, the application displays one of a plurality of different selectable views for the time sheet. The calendar view shows time entries in bar chart form (or in other form) on a day-by-day basis for the time period corresponding to the timesheet. The bars are broken into blocks that are color coded to indicate that time was entered on different projects. The user can also create a new time entry directly from this screen.

When the user elects to create a new time entry, an edit pane slides out that allows the user to enter all details for a time entry, such as the amount of time, the date, the project, category and activity codes, internal and external notes, etc. When the user actuates the submit button from the application bar, the timesheet is entered into workflow.

In various embodiments, the timesheet management application provides a user experience on substantially any form factor (such as on a smart phone, a tablet, a laptop, a desktop, etc.).

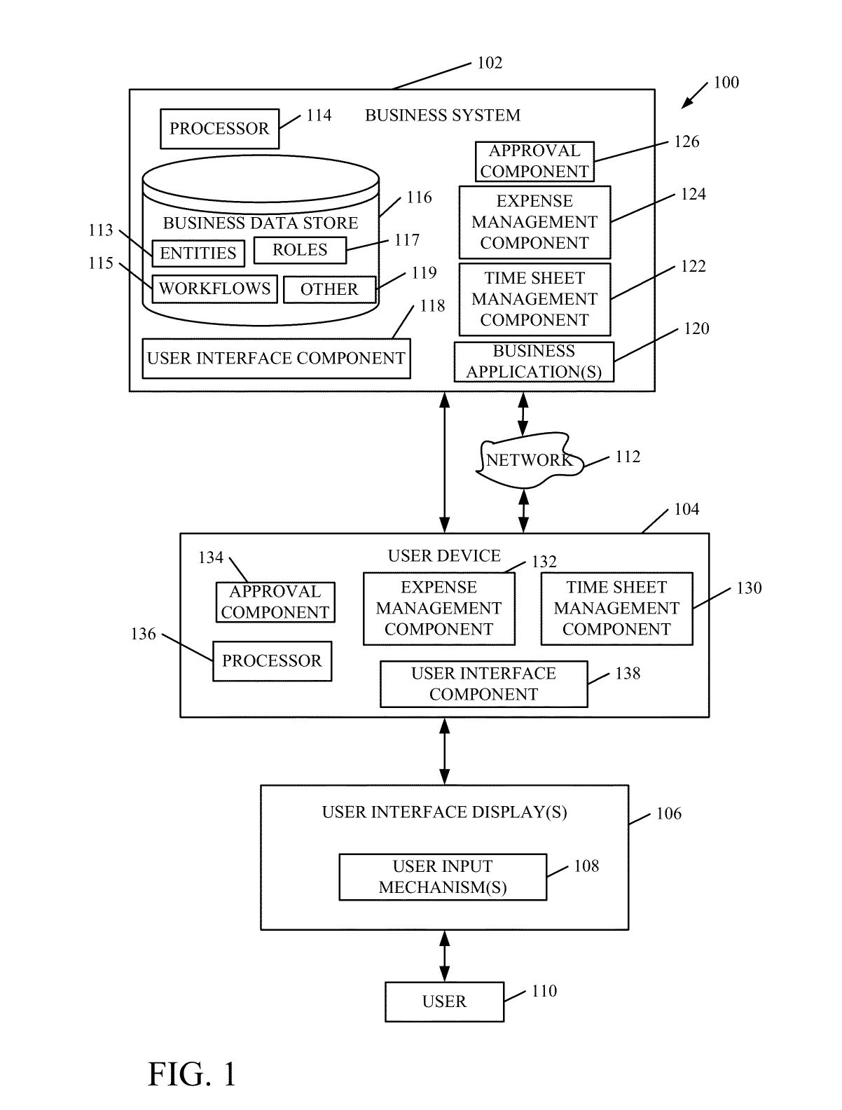

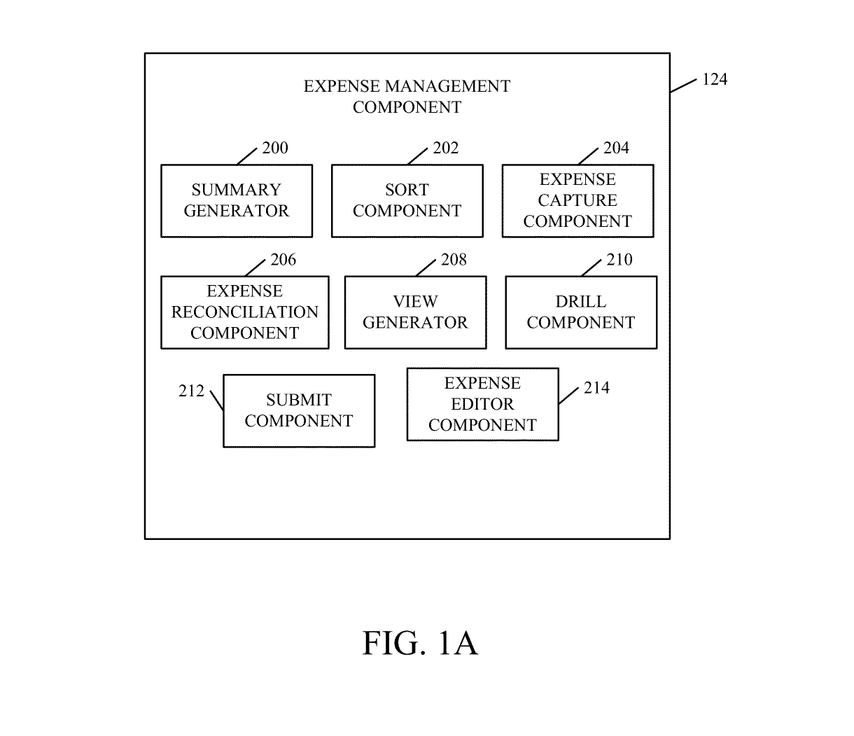

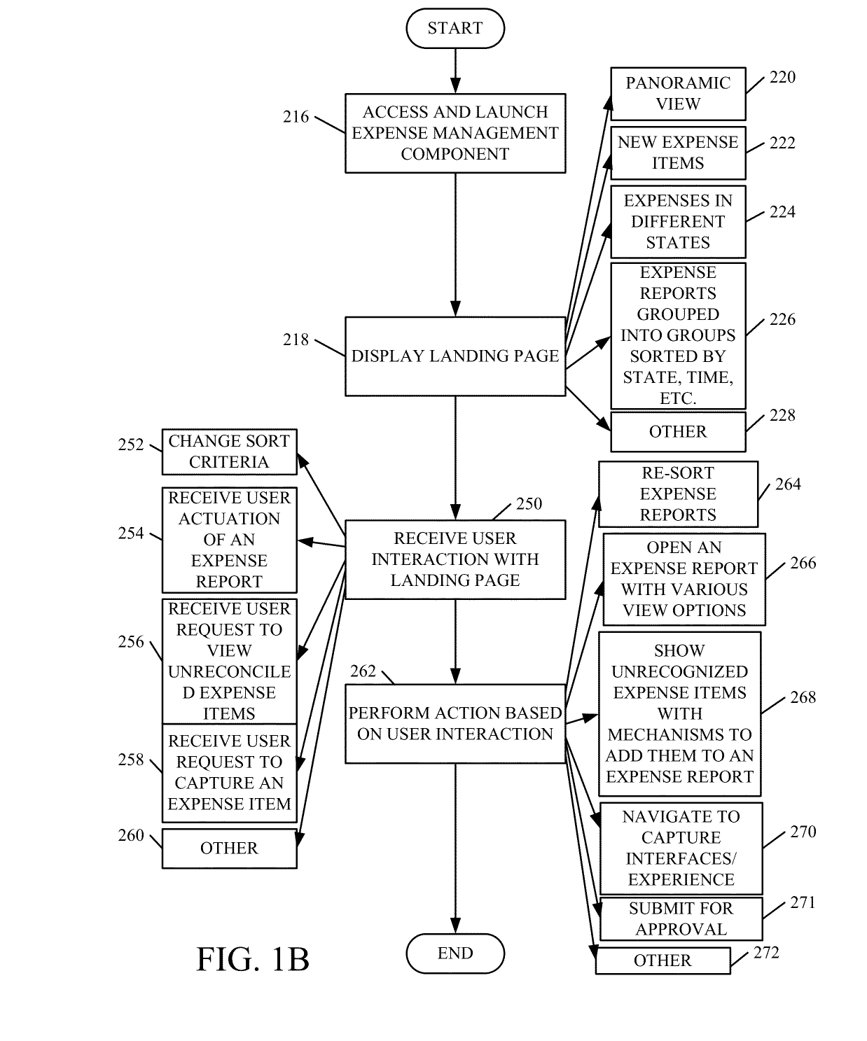

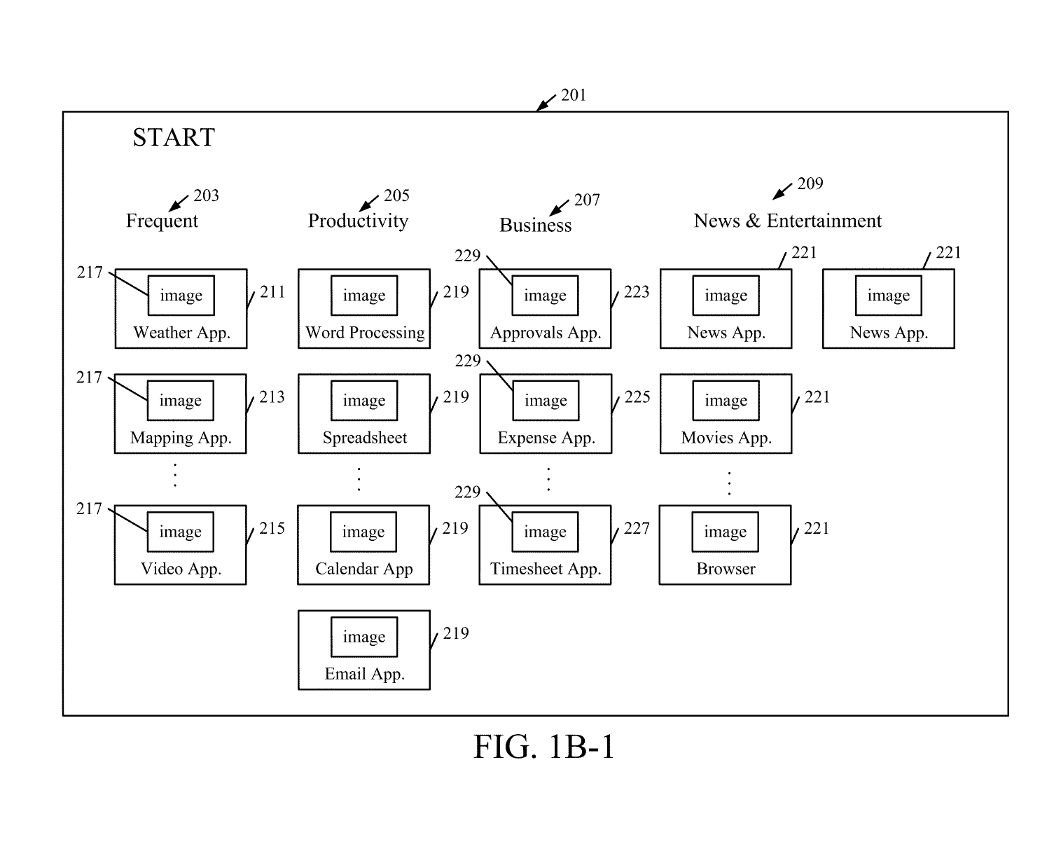

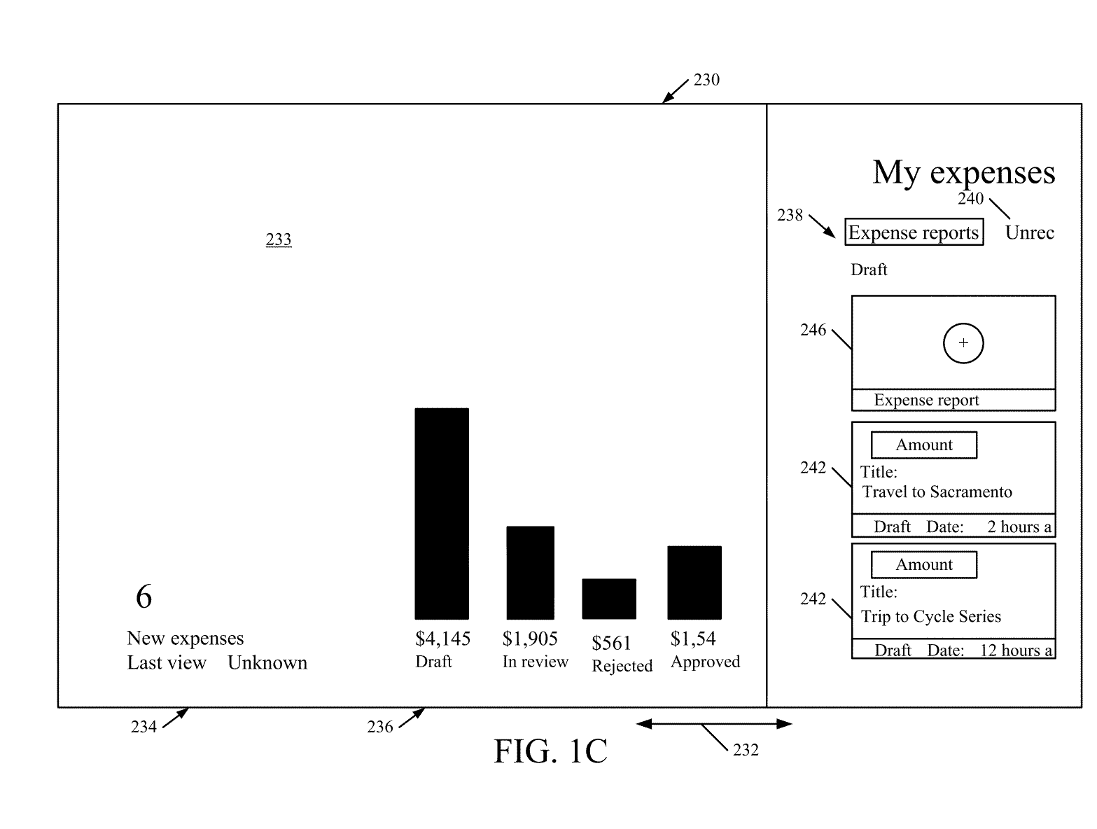

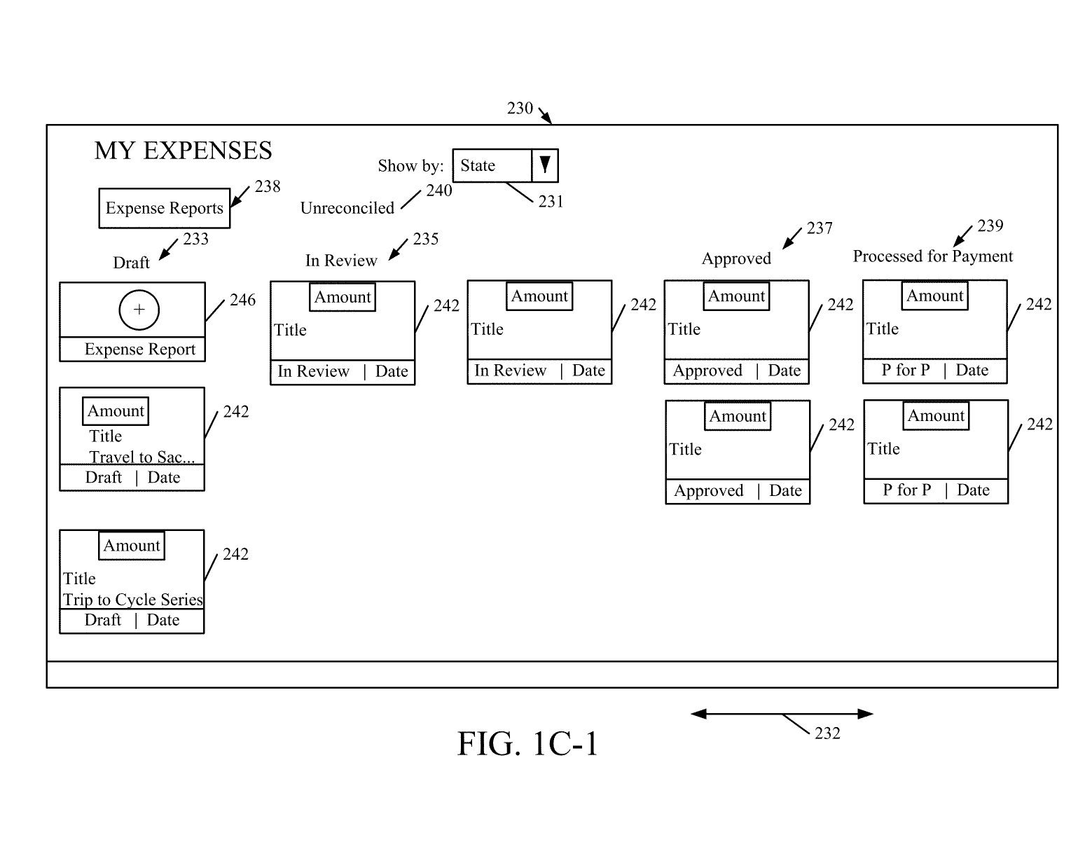

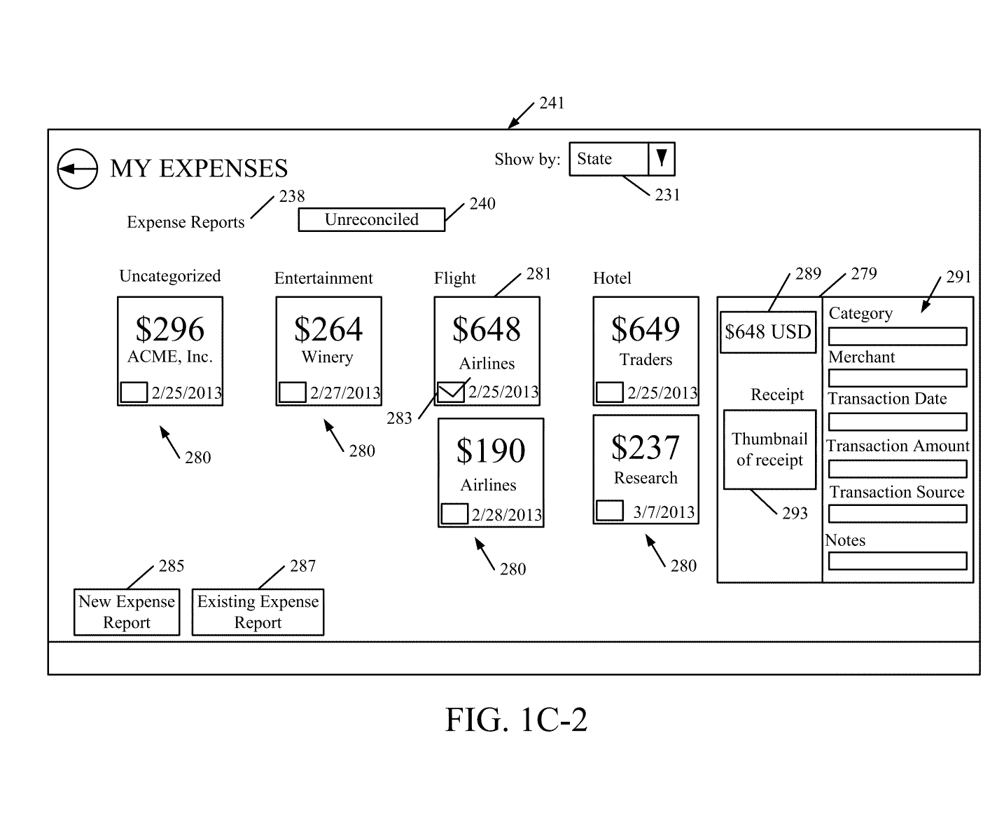

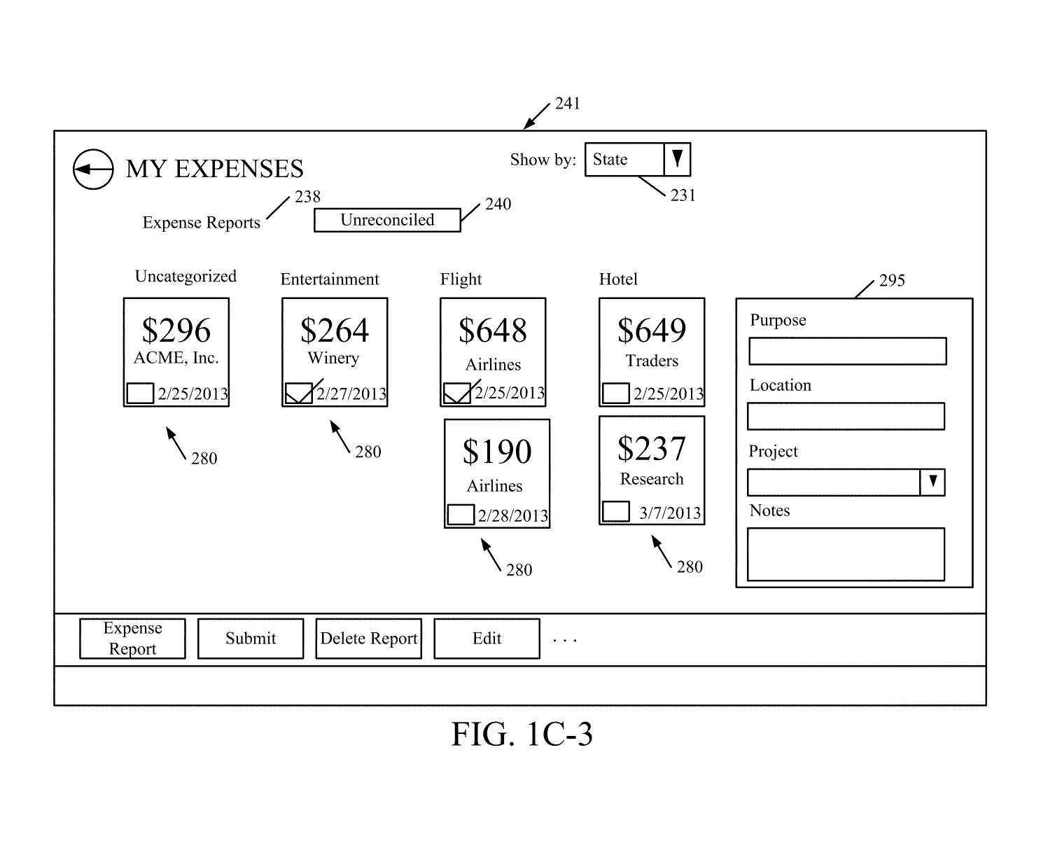

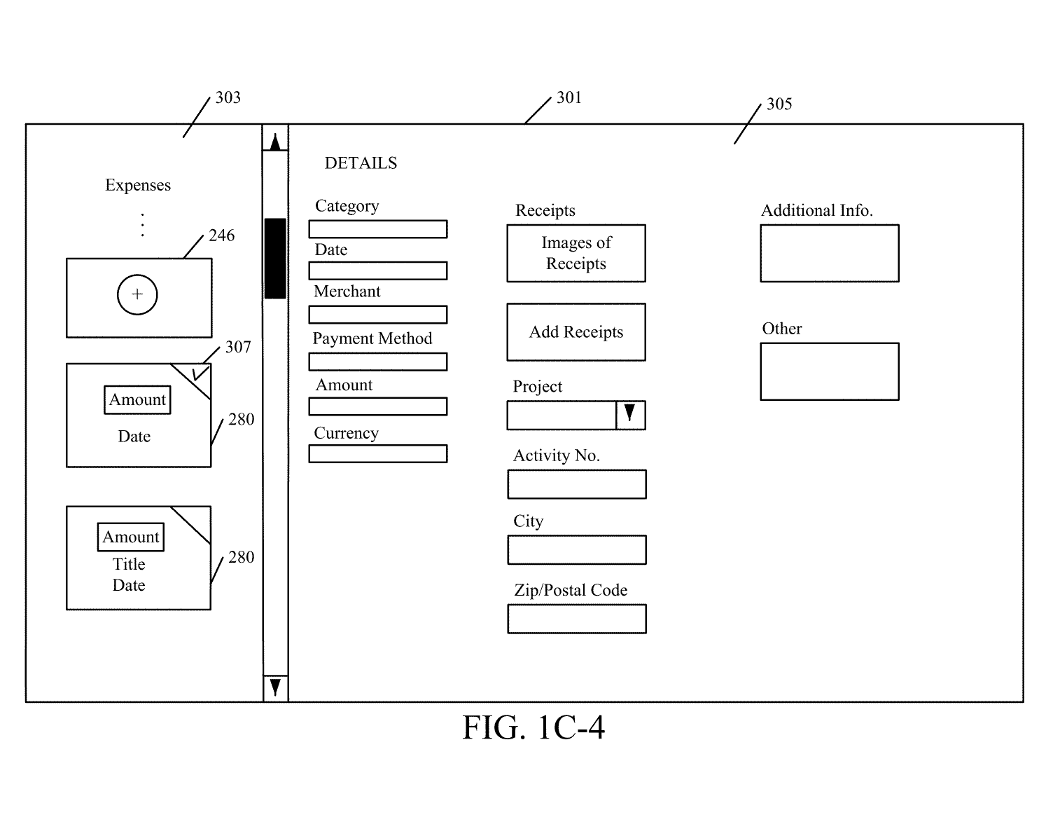

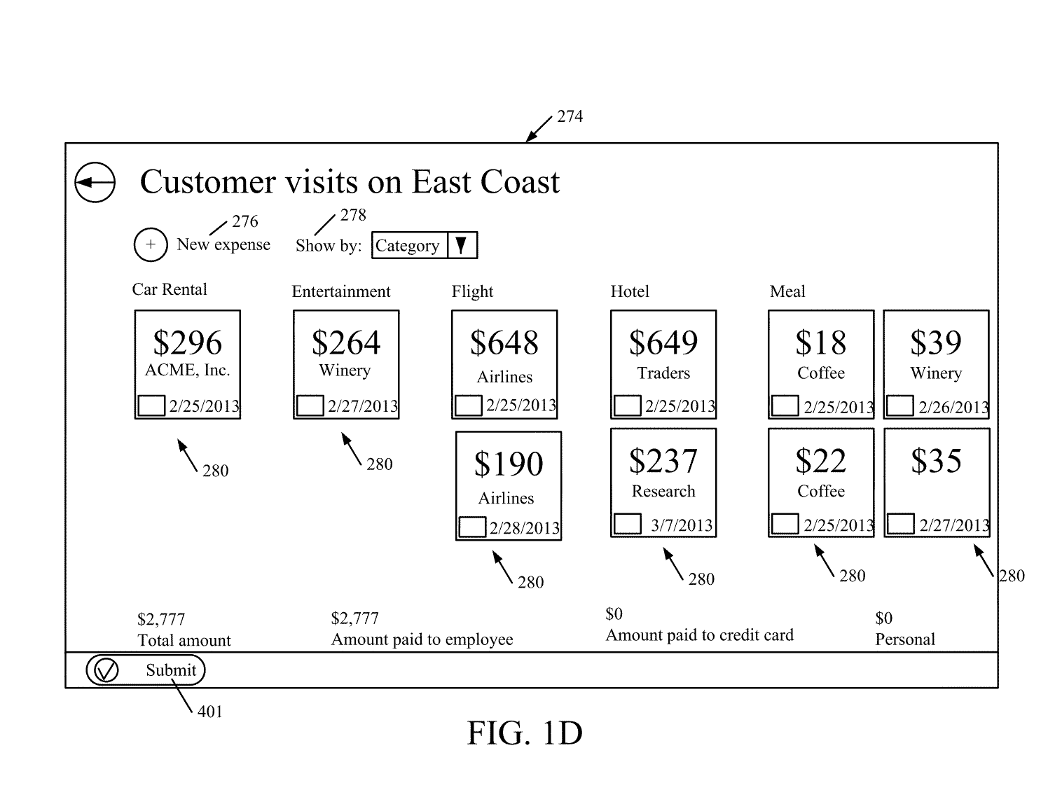

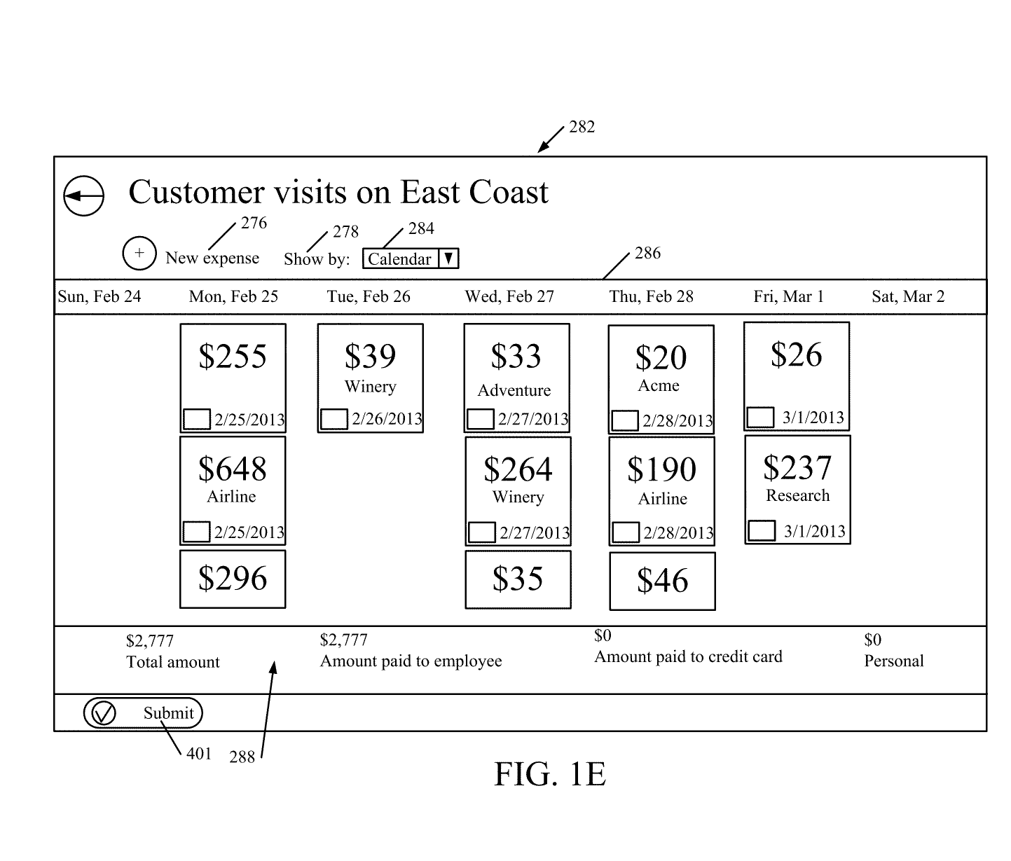

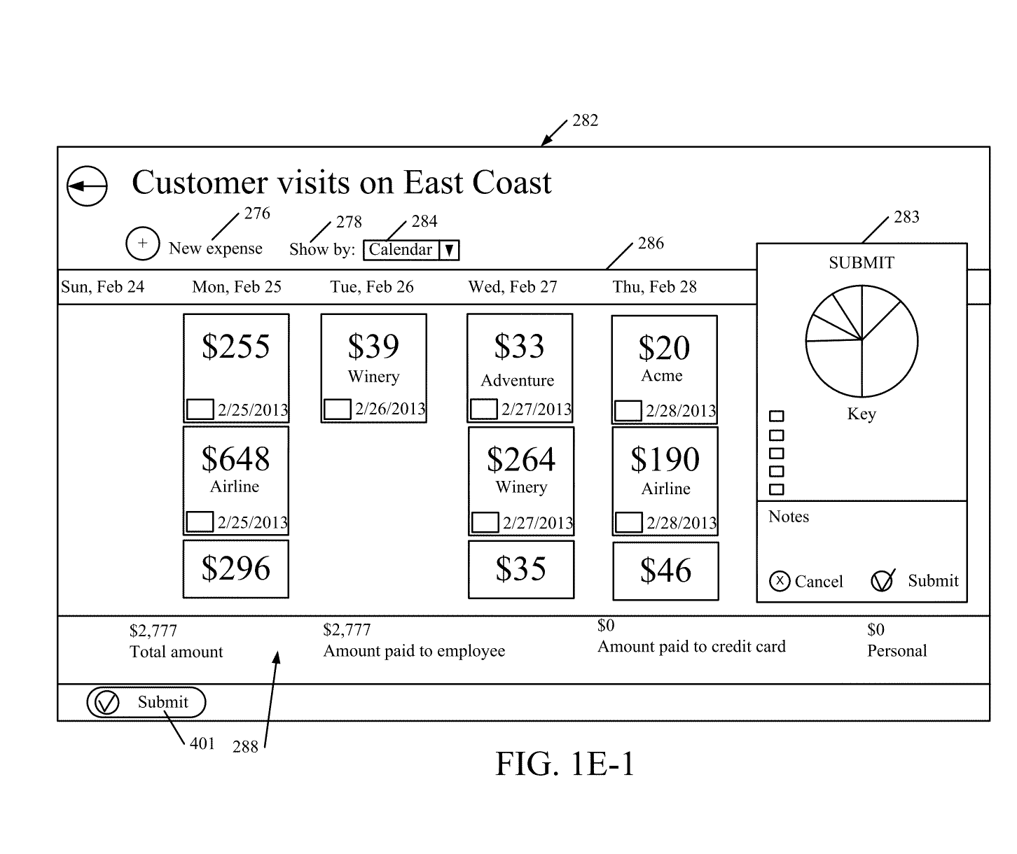

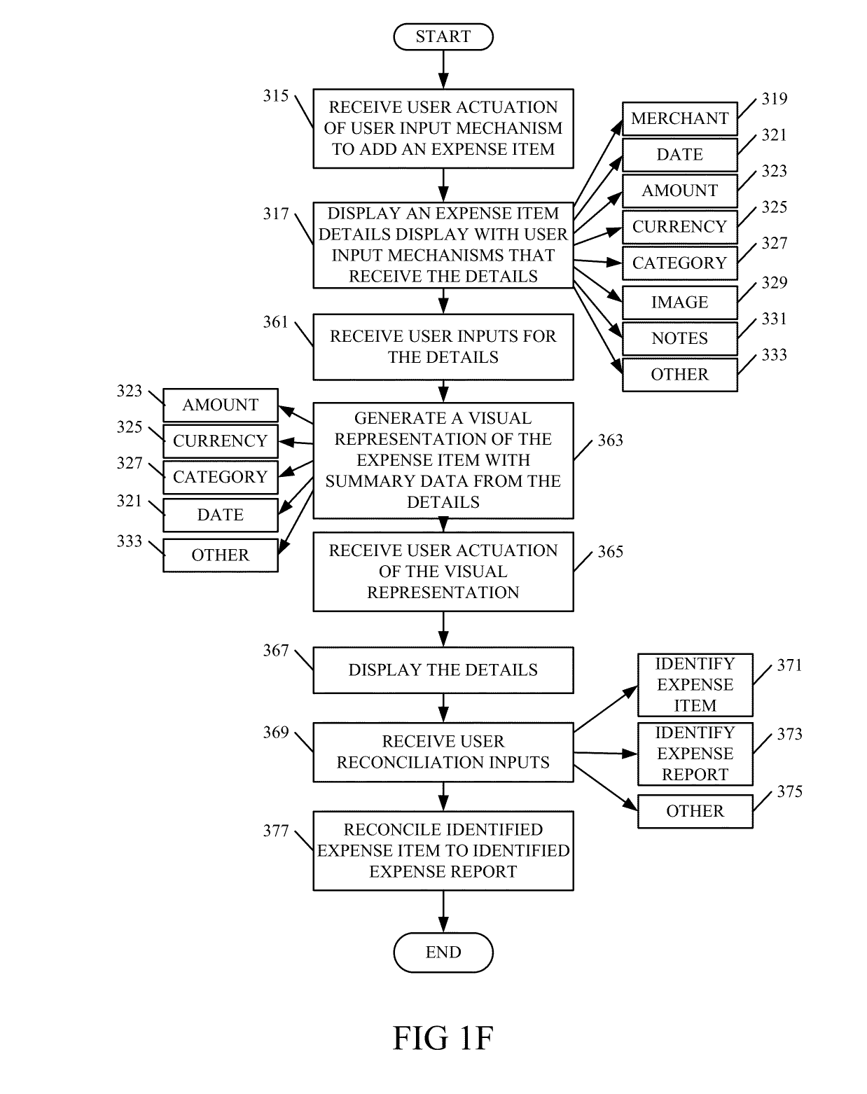

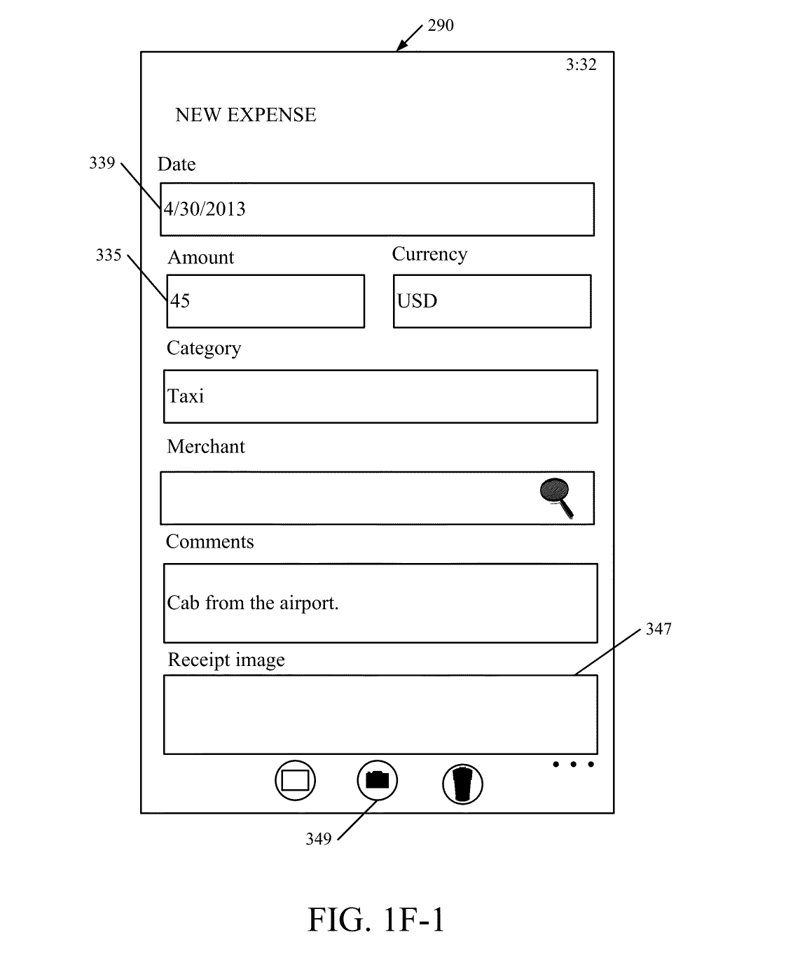

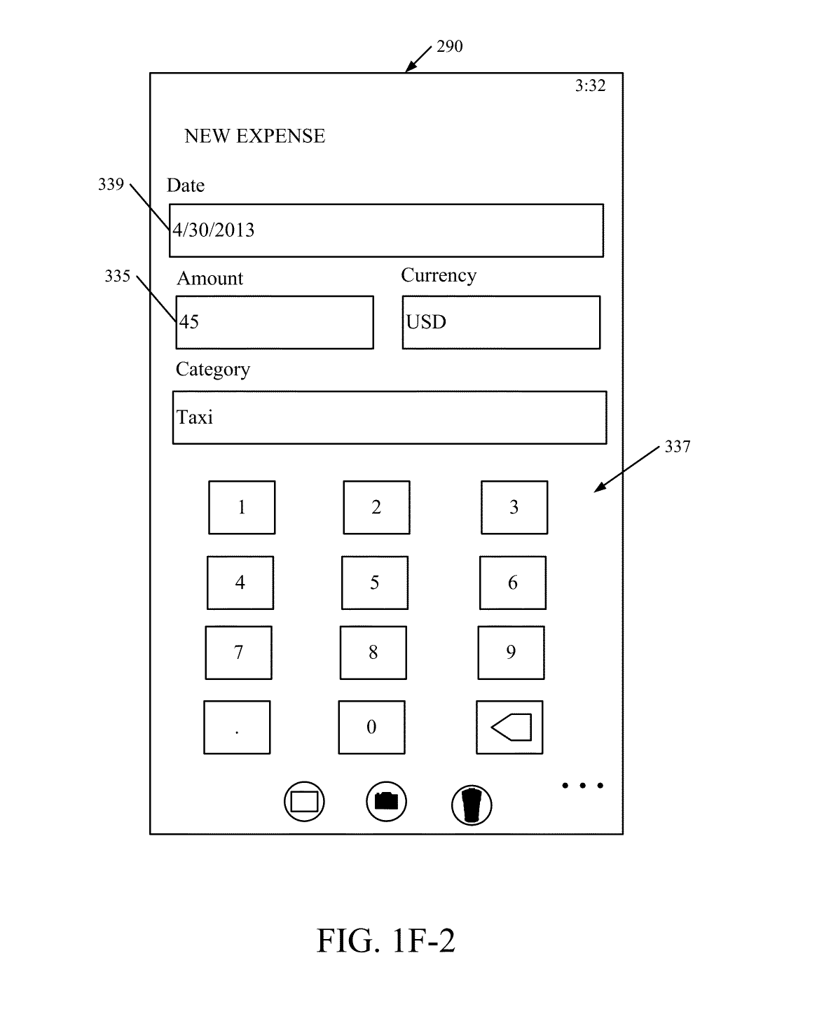

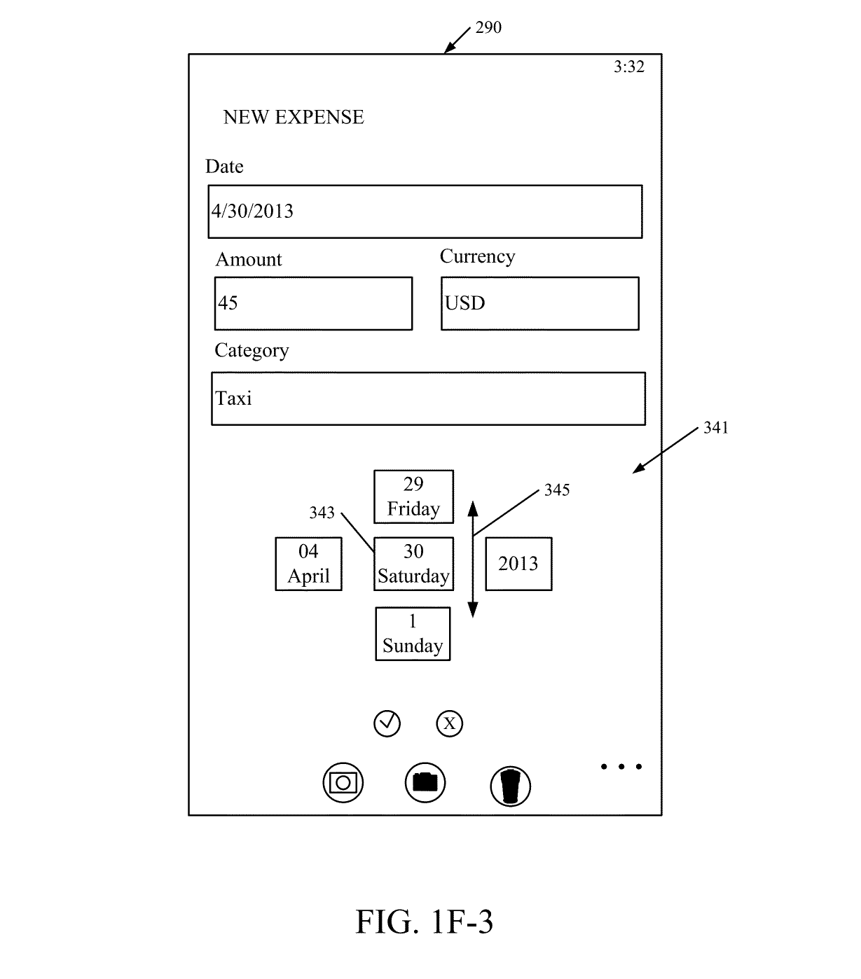

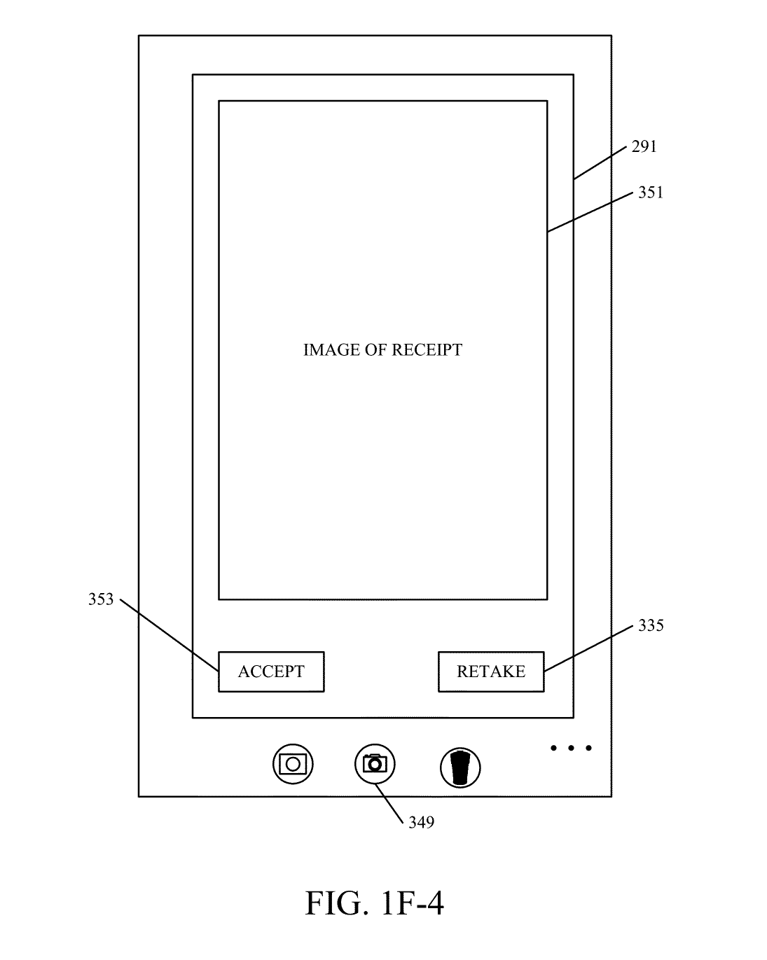

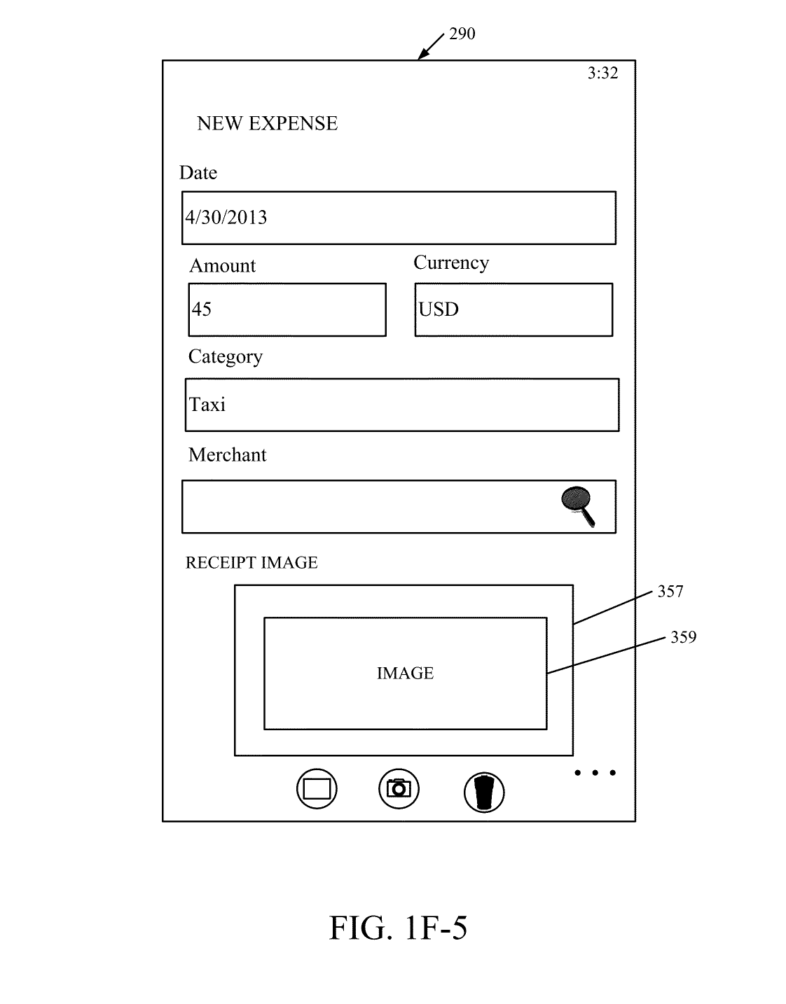

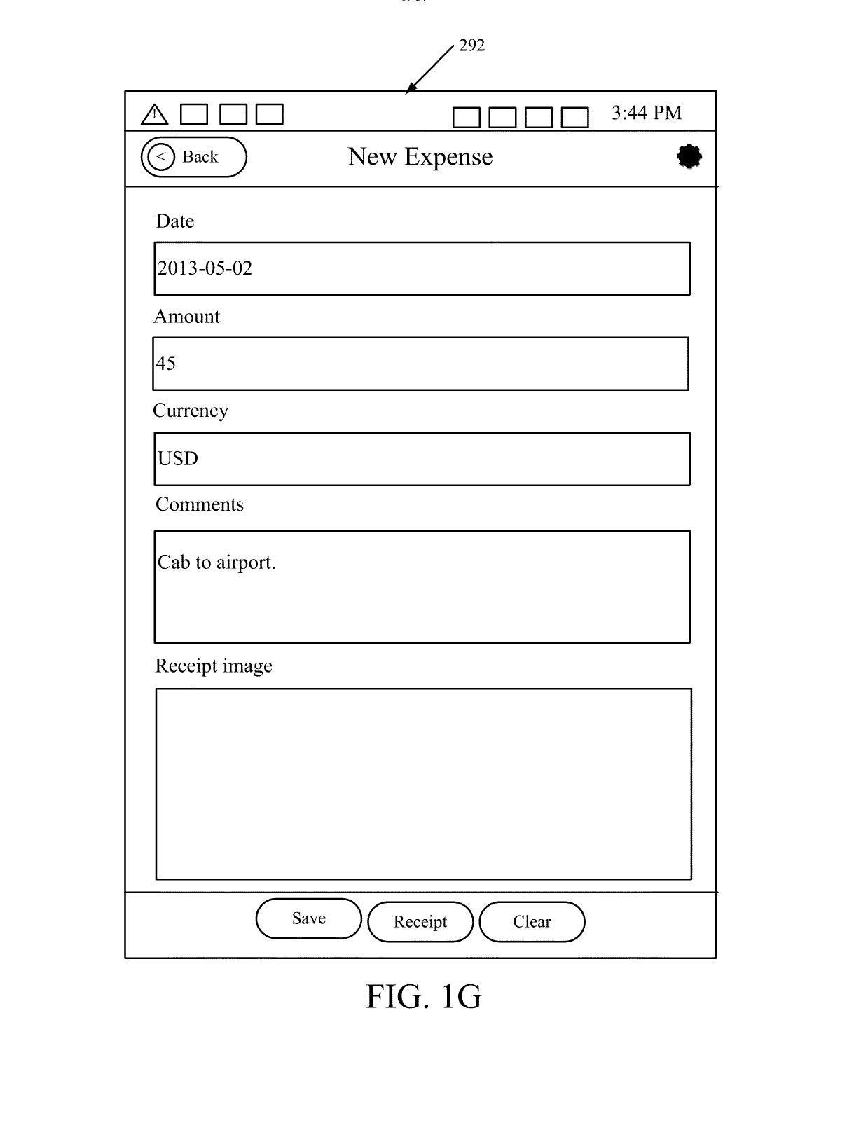

FIG. 1 is a block diagram of one illustrative business system architecture 100. Architecture 100 includes business system 102 that is accessed by user device 104. User device 104 generates user interface displays 106, with user input mechanisms 108, for interaction by user 110. It can be seen in FIG. 1 that user device 104 can access business system 102 directly, or over a network 112.

Business system 102 illustratively includes processor 114, business data store 116, user interface component 118, one or more business applications 120, timesheet management component 122, expense management component 124 and approval component 126. Of course, business system 102 can include fewer, more or different items or components as well.

Business system 102 illustratively runs one or more business applications 120, that run various workflows and operate on business data in business data store 116, and allow various users to perform business operations, tasks, or activities, within business system 102. By way of example, business applications 120 can be a wide variety of different types of business applications used in different types of business systems. For instance, they can include customer relations management (CRM) applications, enterprise resource planning (ERP) applications, line-of-business (LOB) applications, among others.

Expense management component 124 allows users to capture expense items and reconcile those individual expense items to expense reports. The expense items in a given report can be sorted and viewed in a variety of different ways, and the given expense report can be submitted for approval. Expense management component 124 is described below with respect to FIGS. 1A-1G.

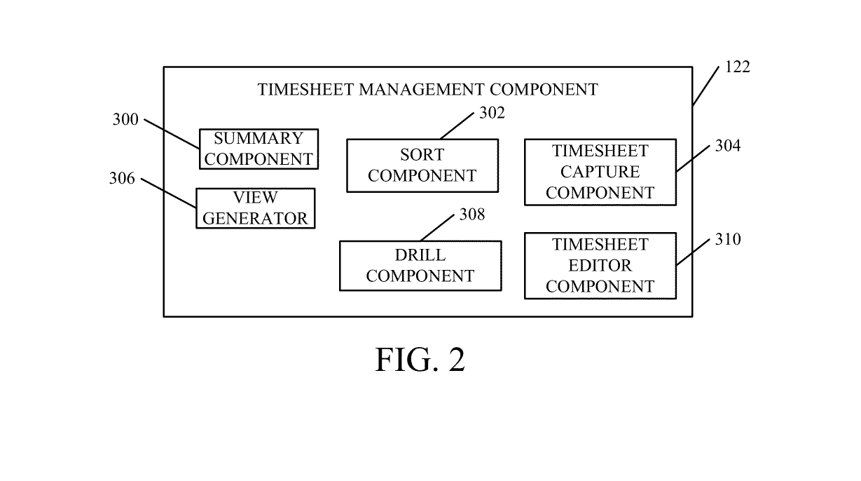

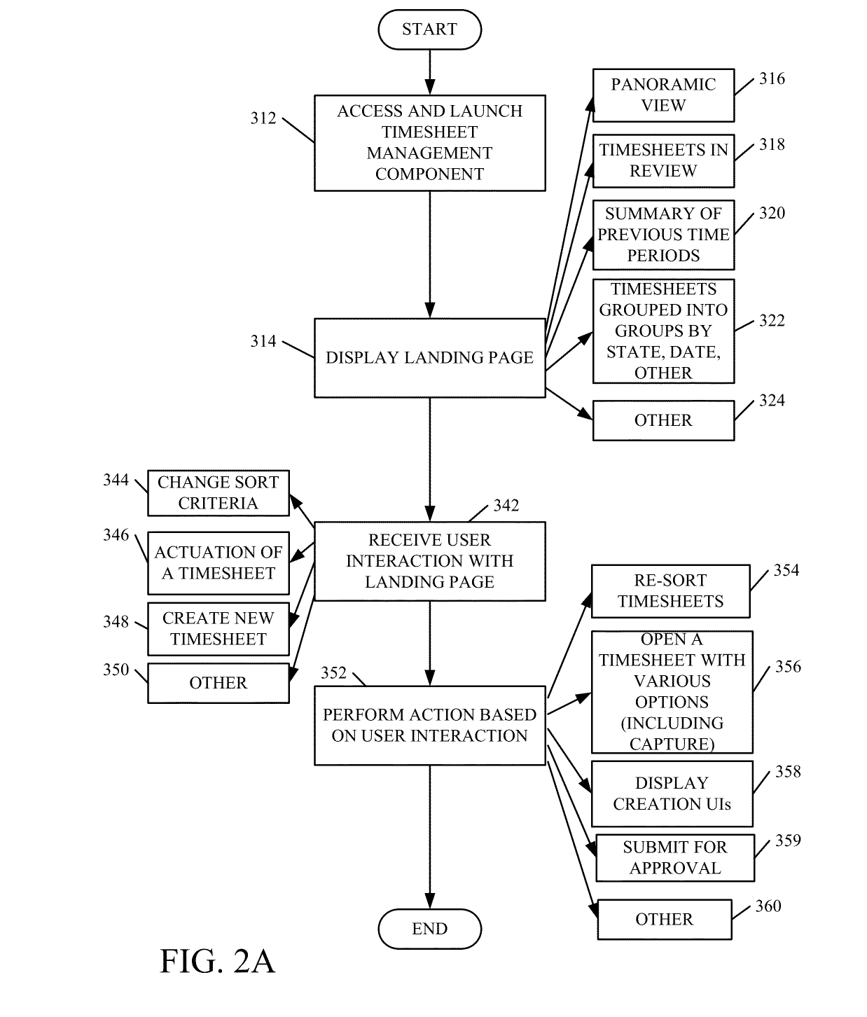

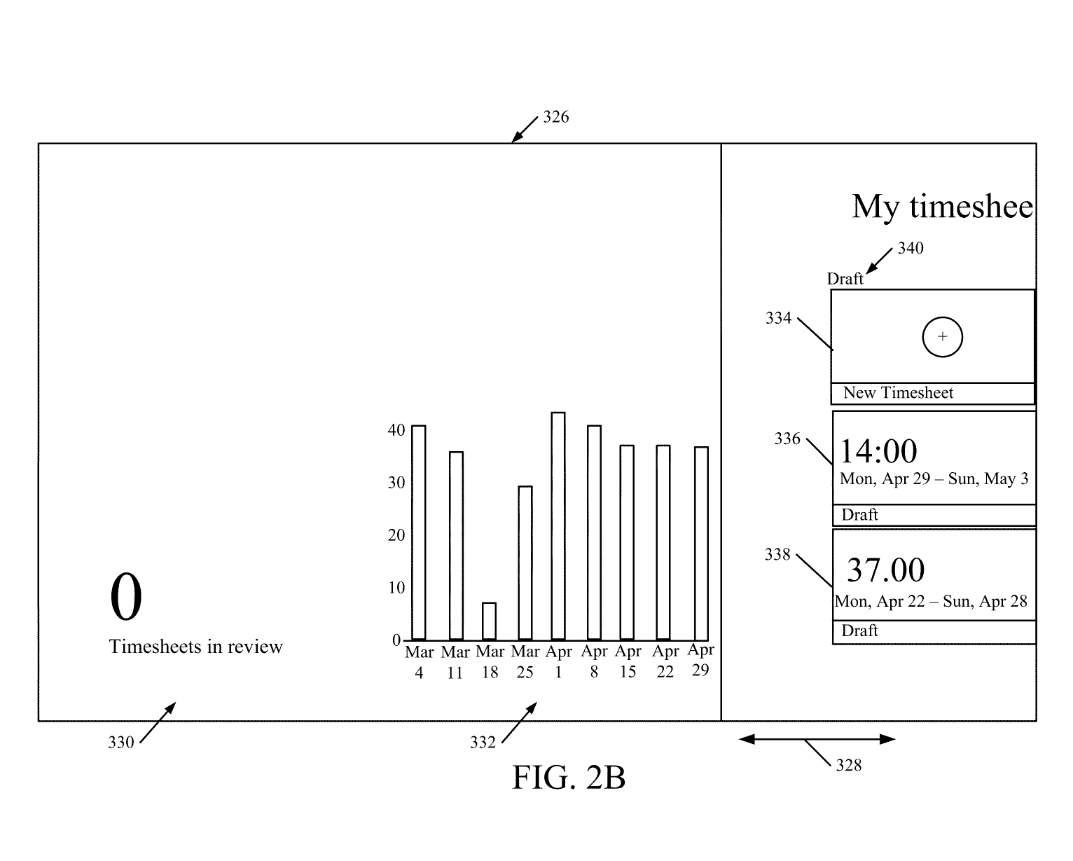

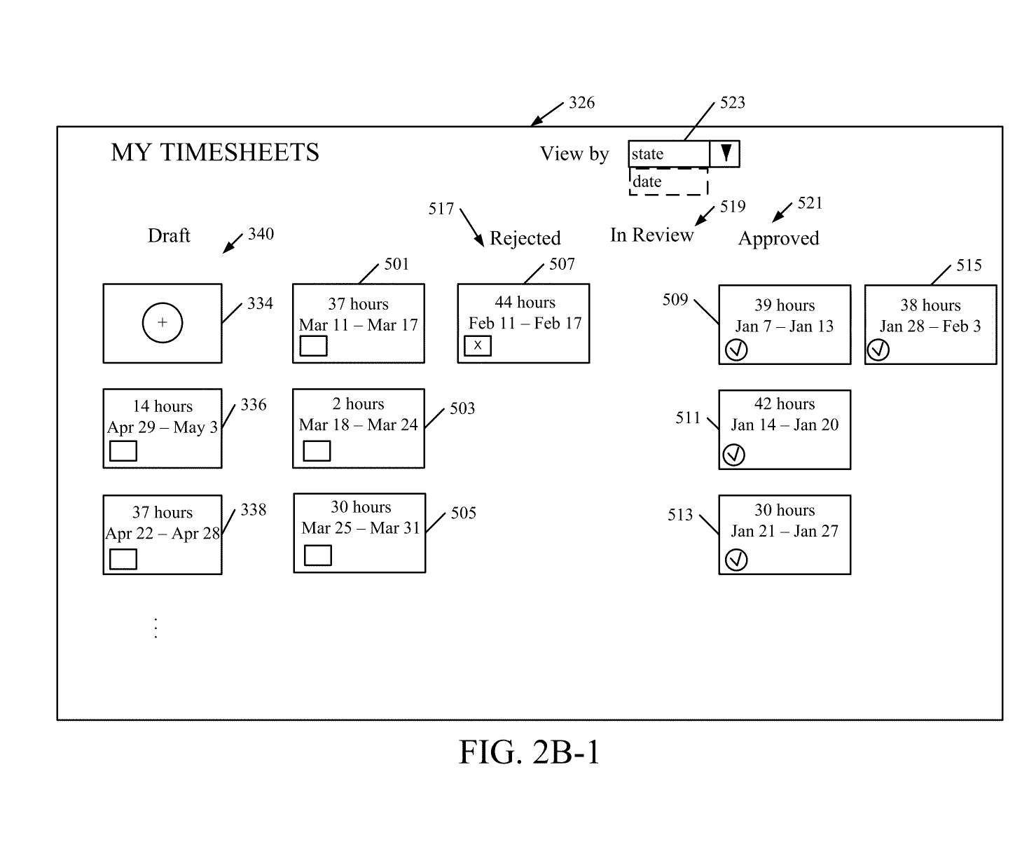

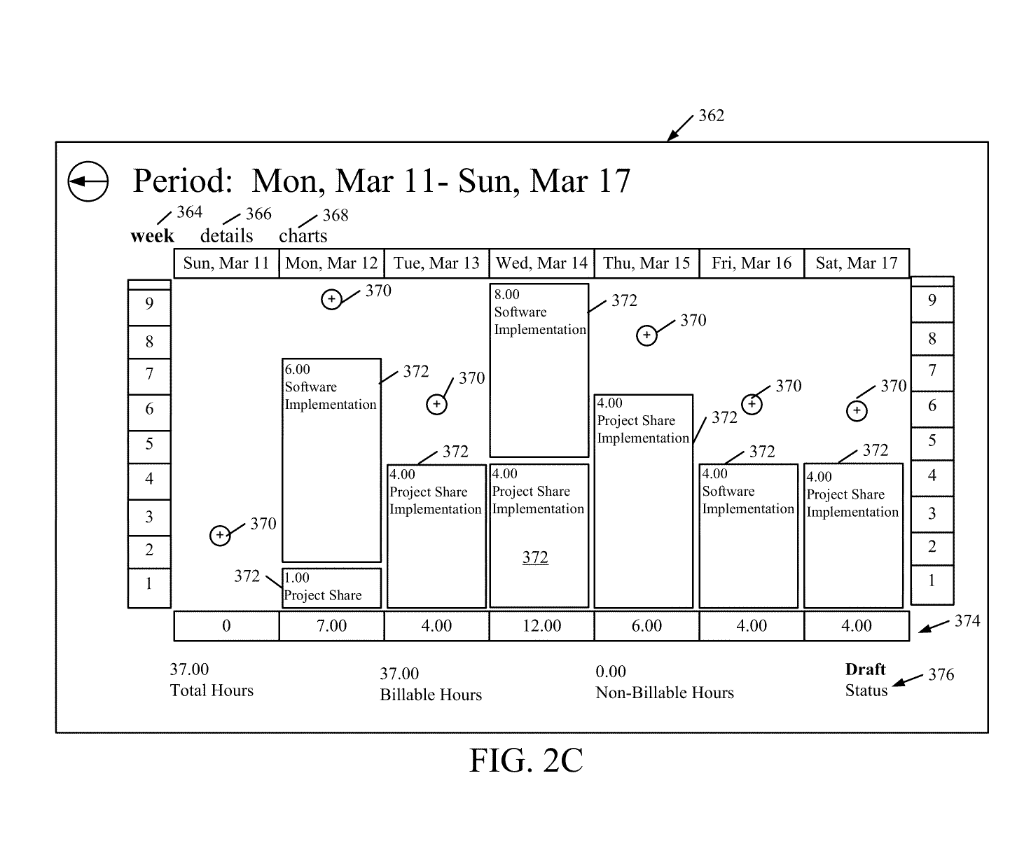

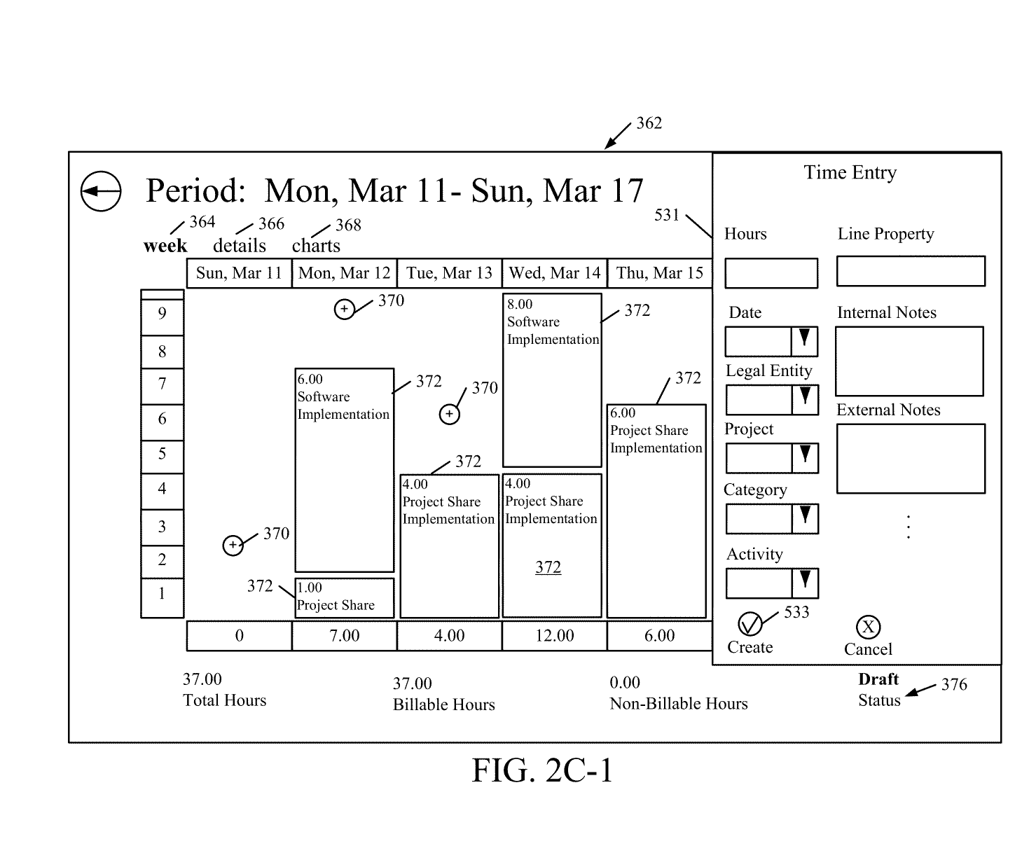

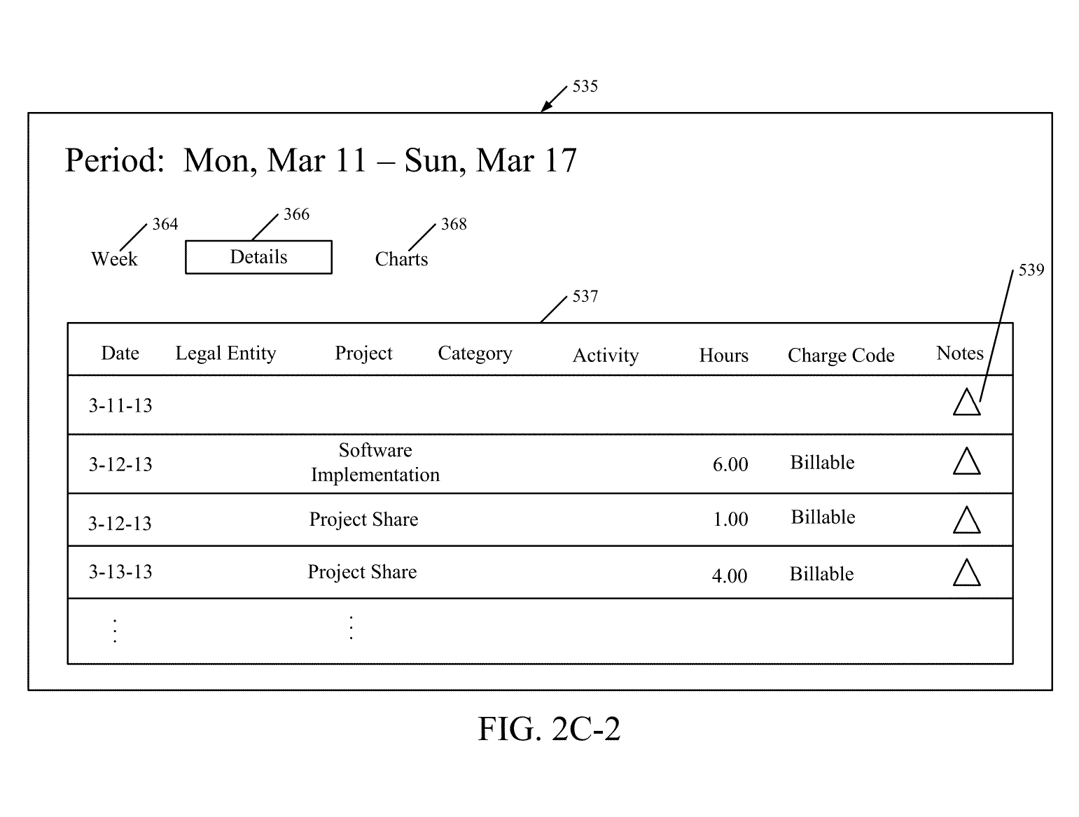

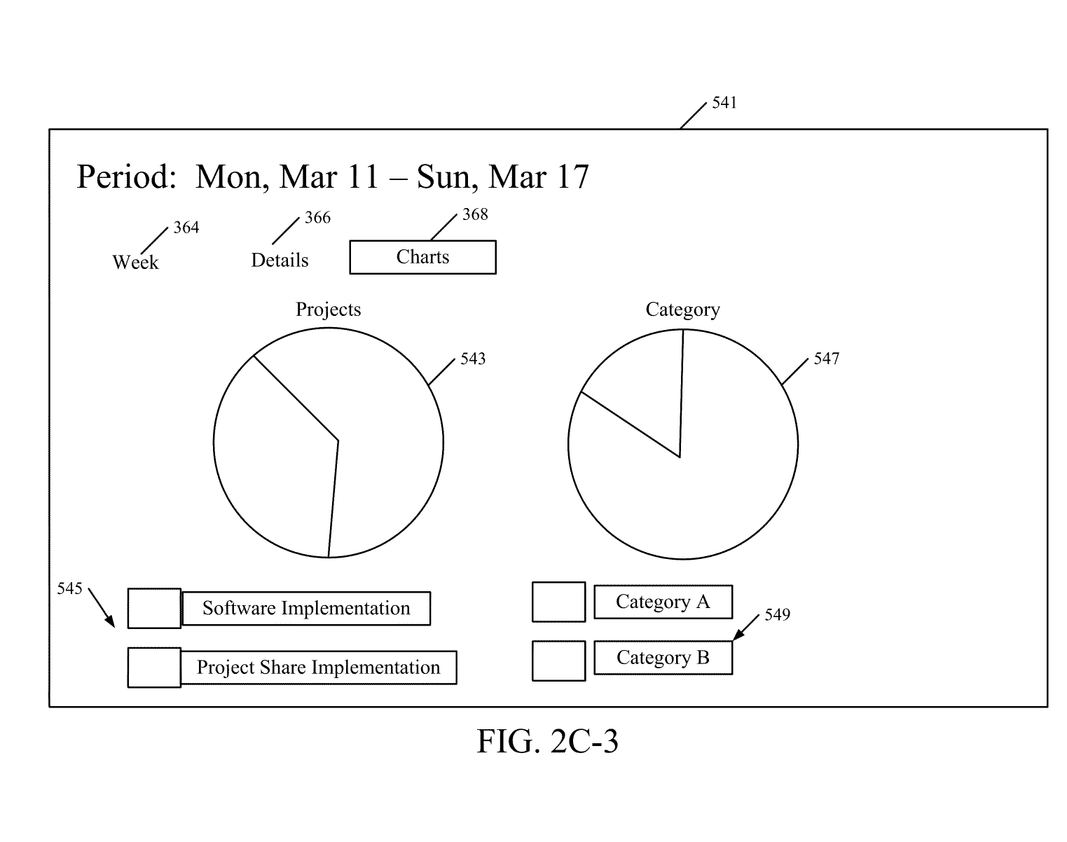

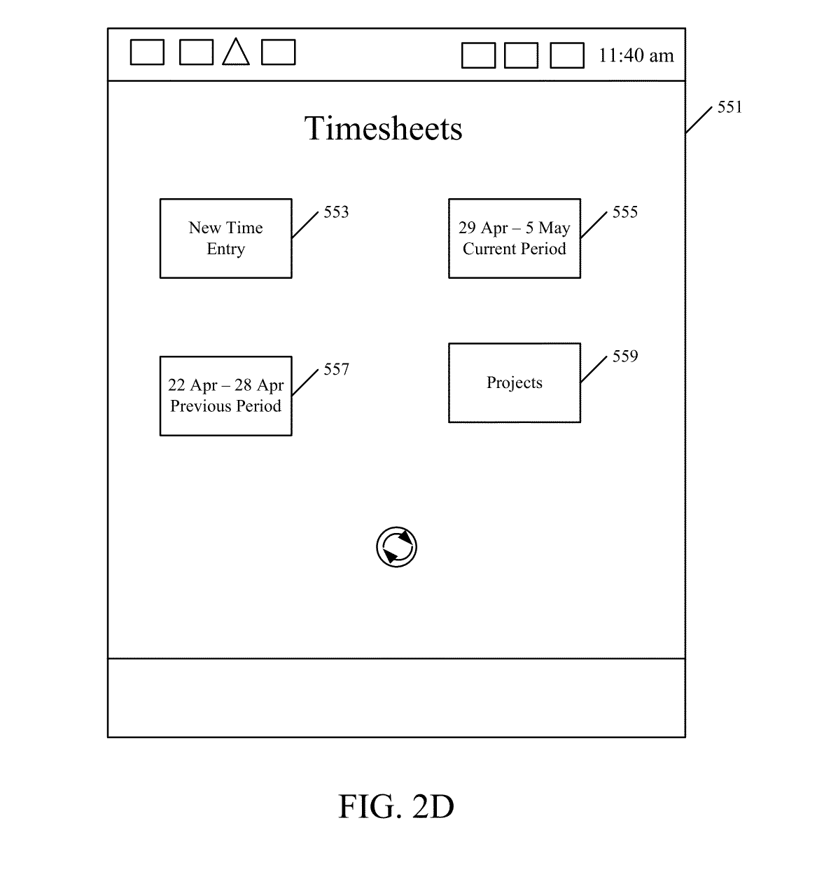

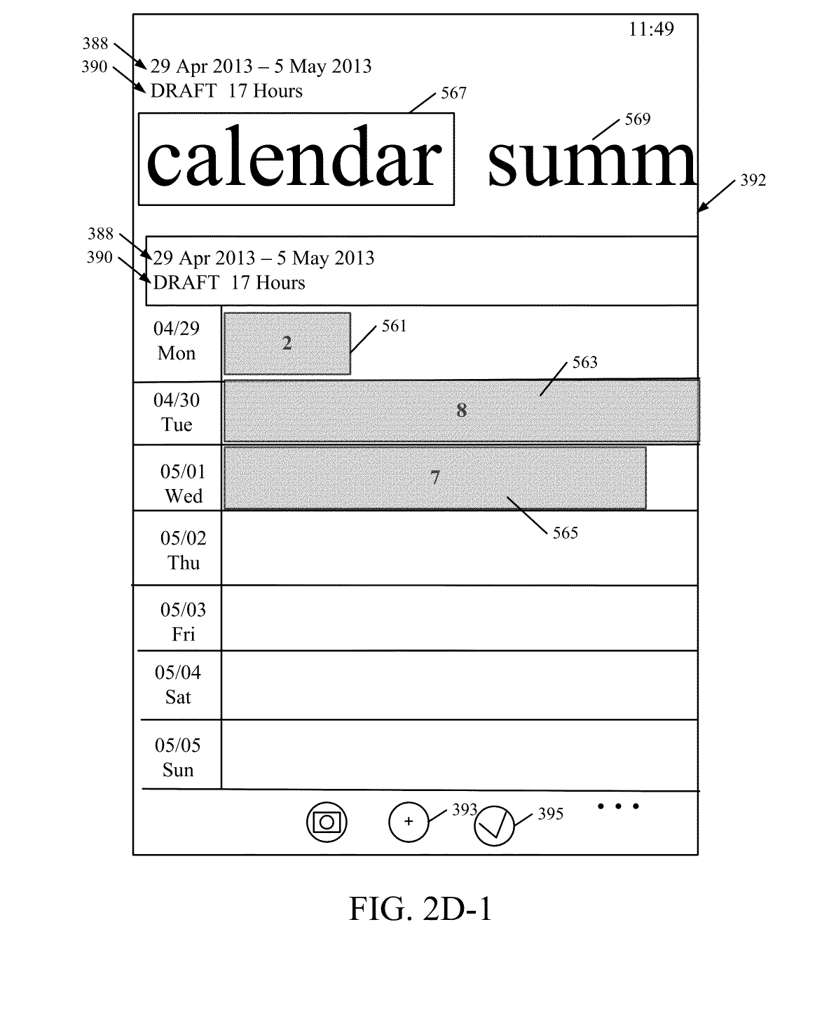

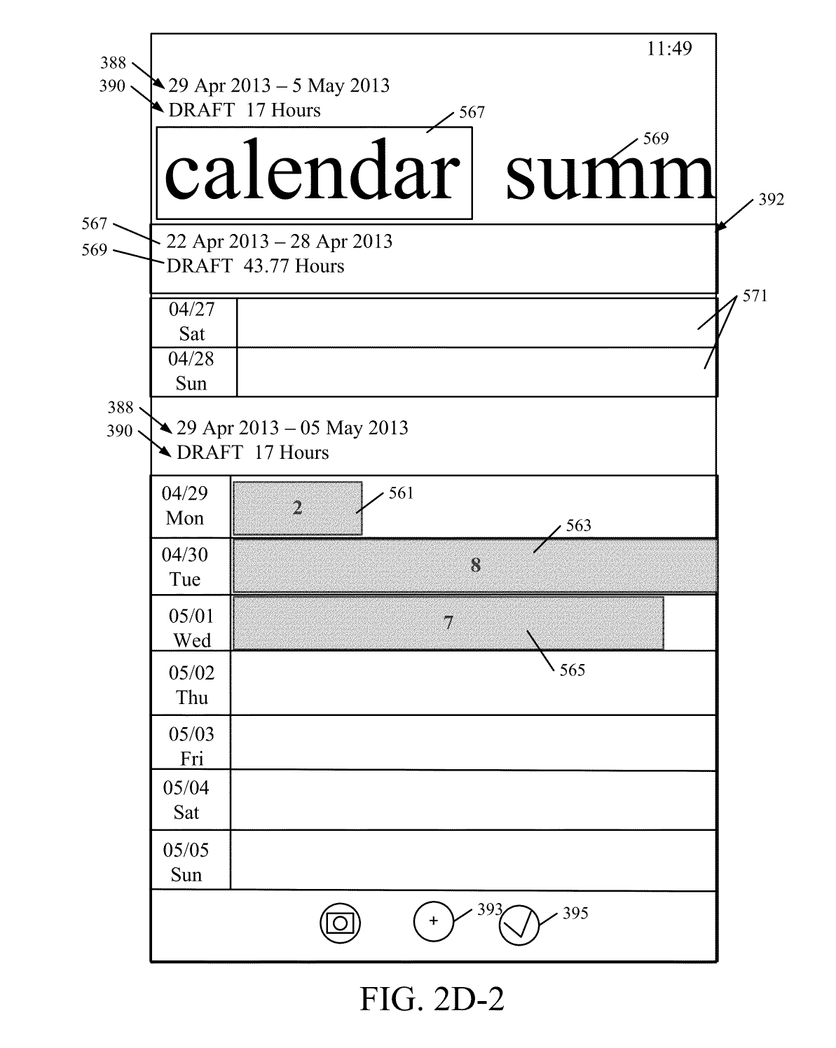

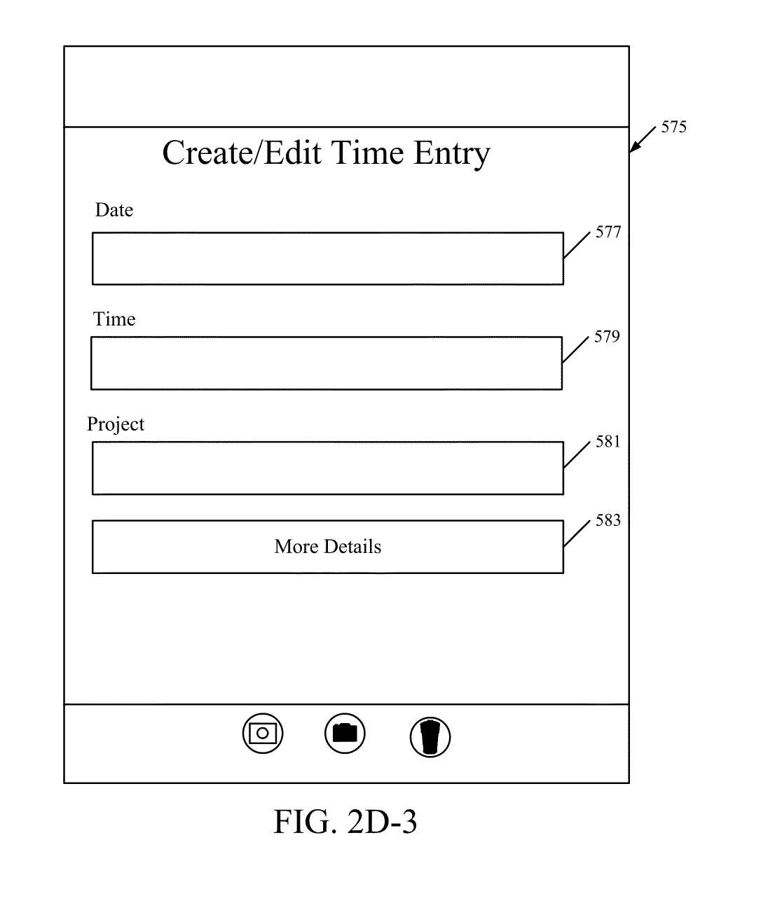

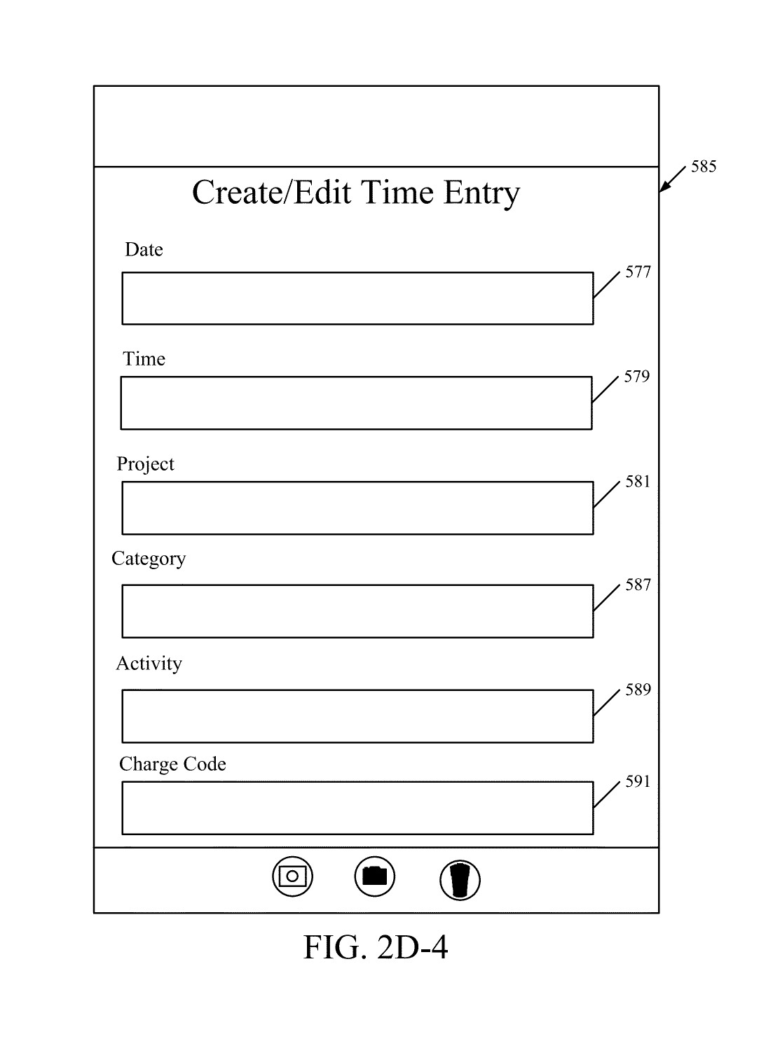

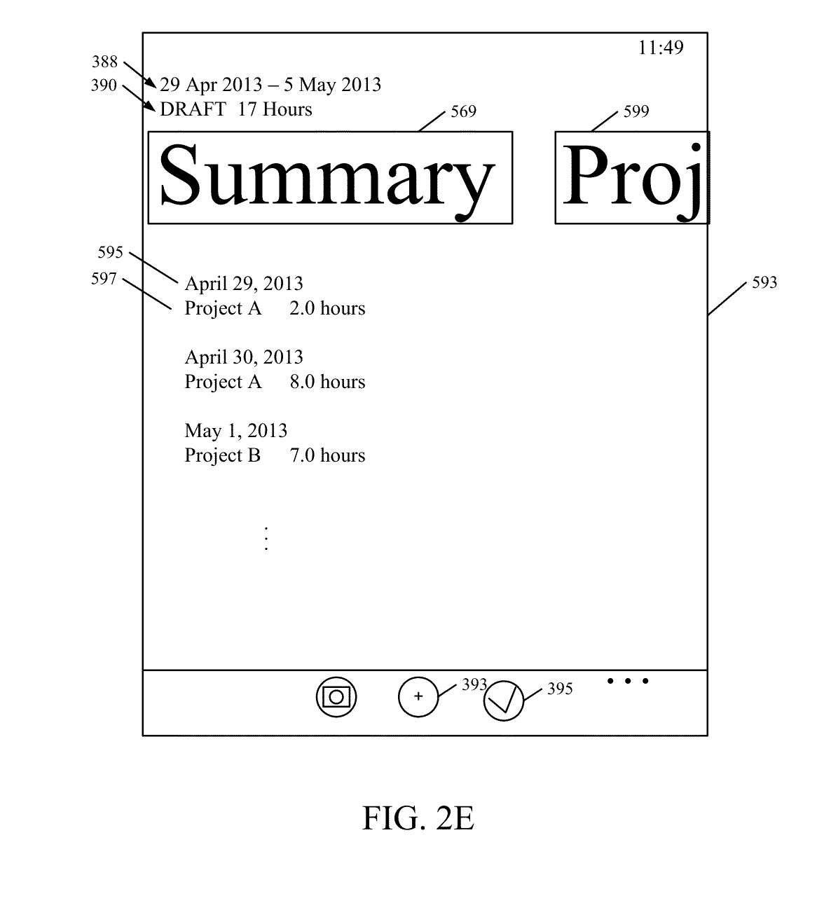

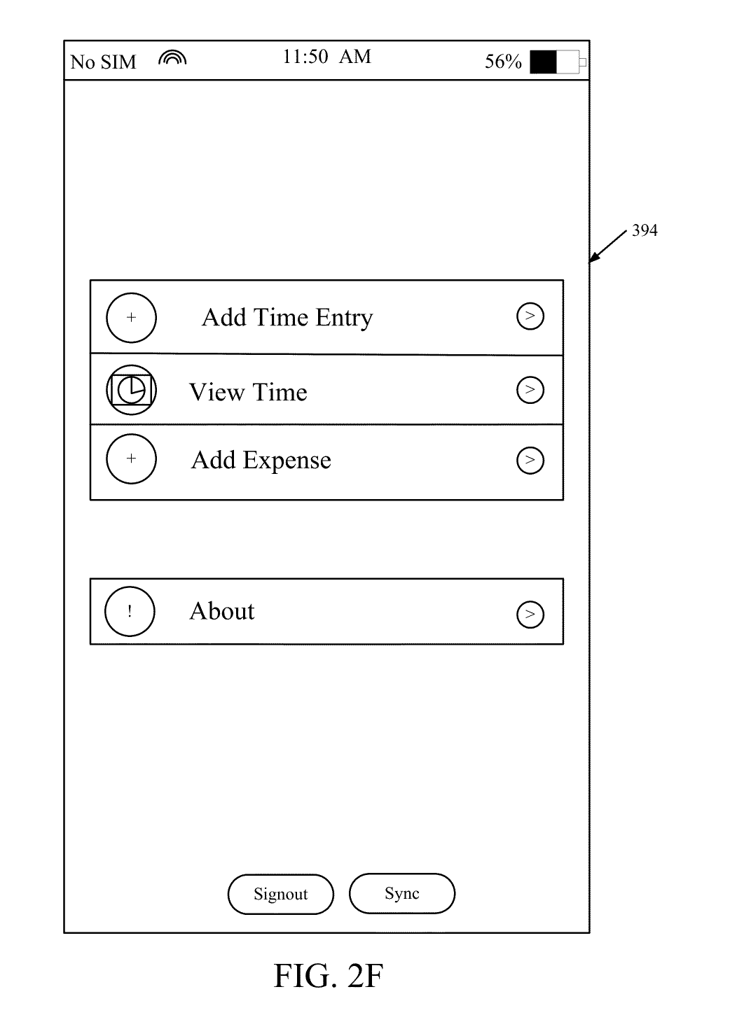

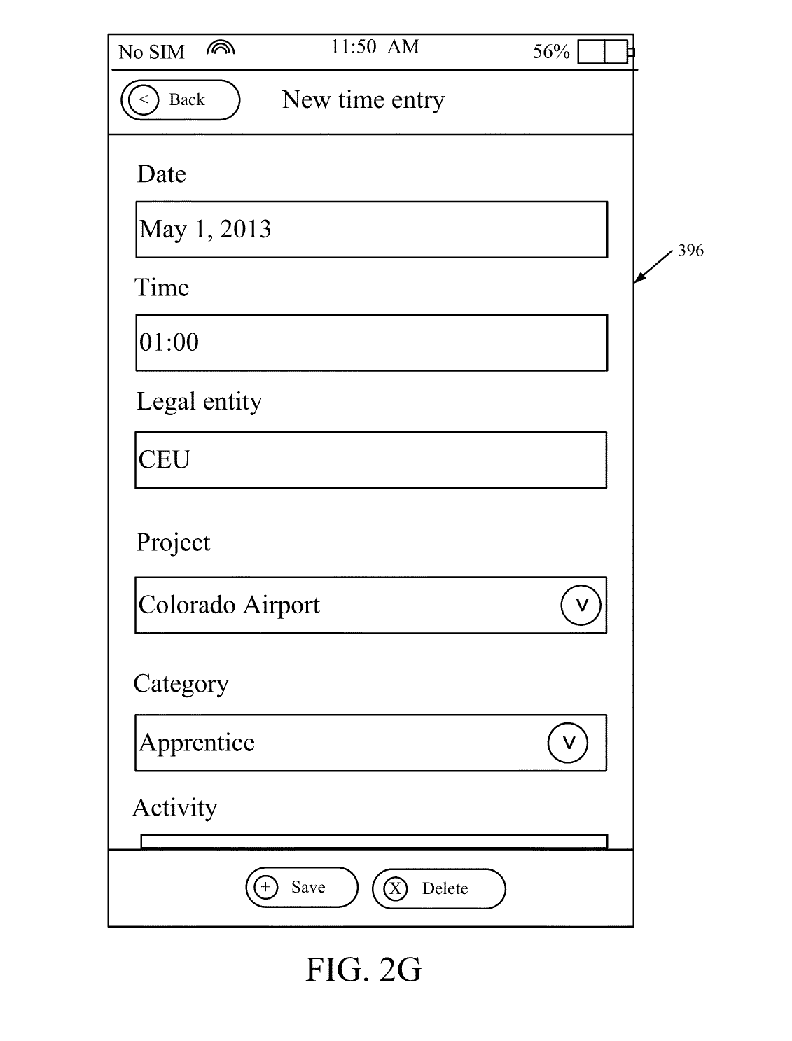

Timesheet management component 122 illustratively allows users to manage timesheets. By way of example, it may be that users are asked, by the business, to make time entries on time sheets so that the time entries can be submitted for approval and billed against various projects, or to various customers. Timesheet management component 122 allows users to enter time entries, and perform other management operations with respect to timesheets (or timecards). Timesheet management component 122 is described in greater detail below with respect to FIGS. 2-2G.

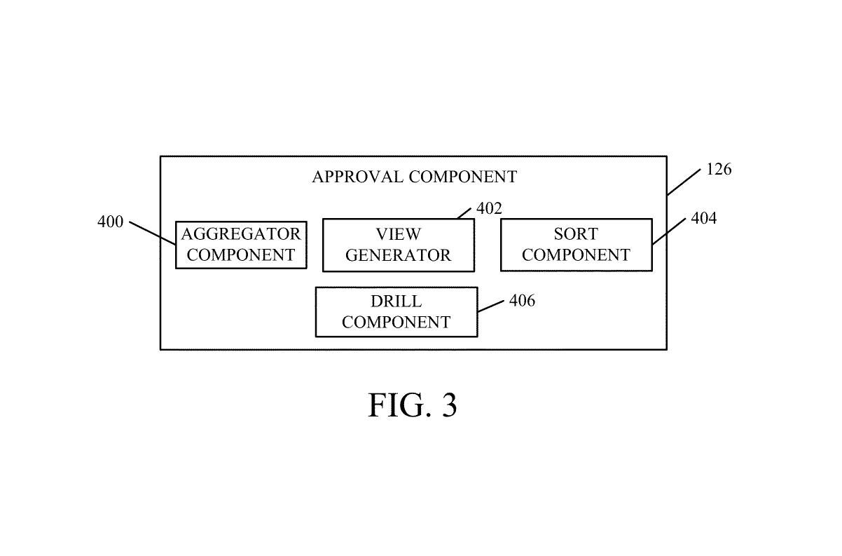

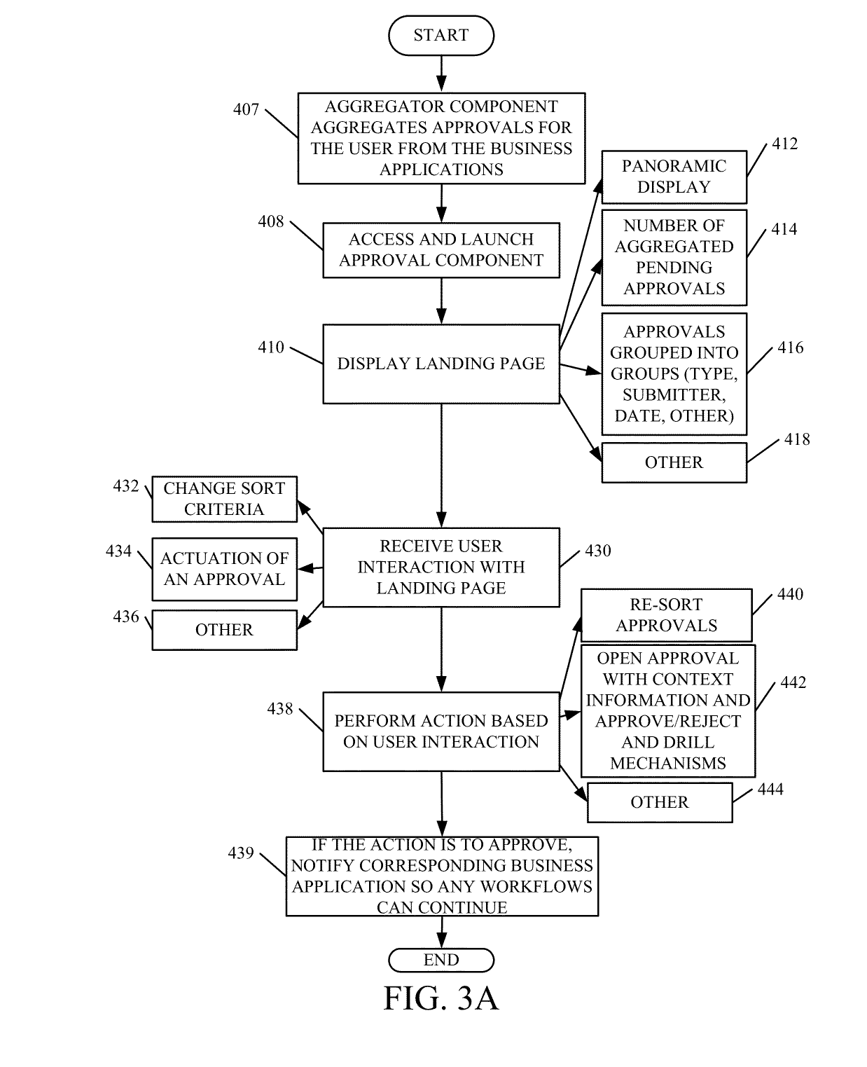

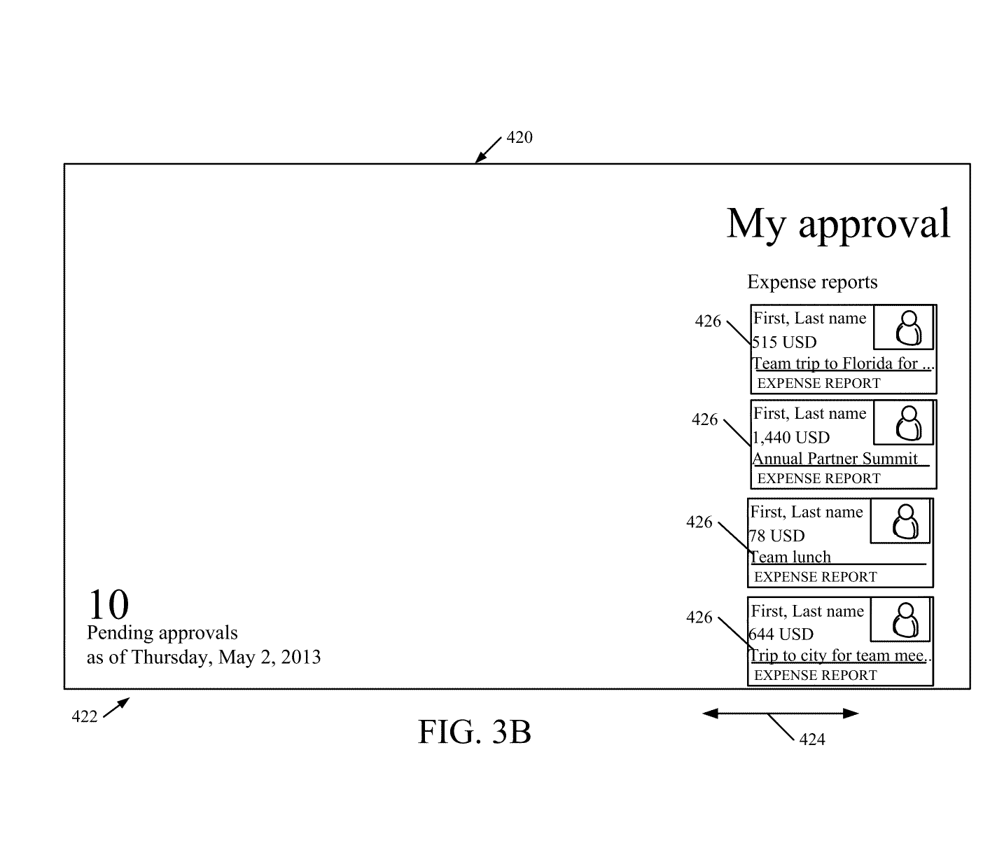

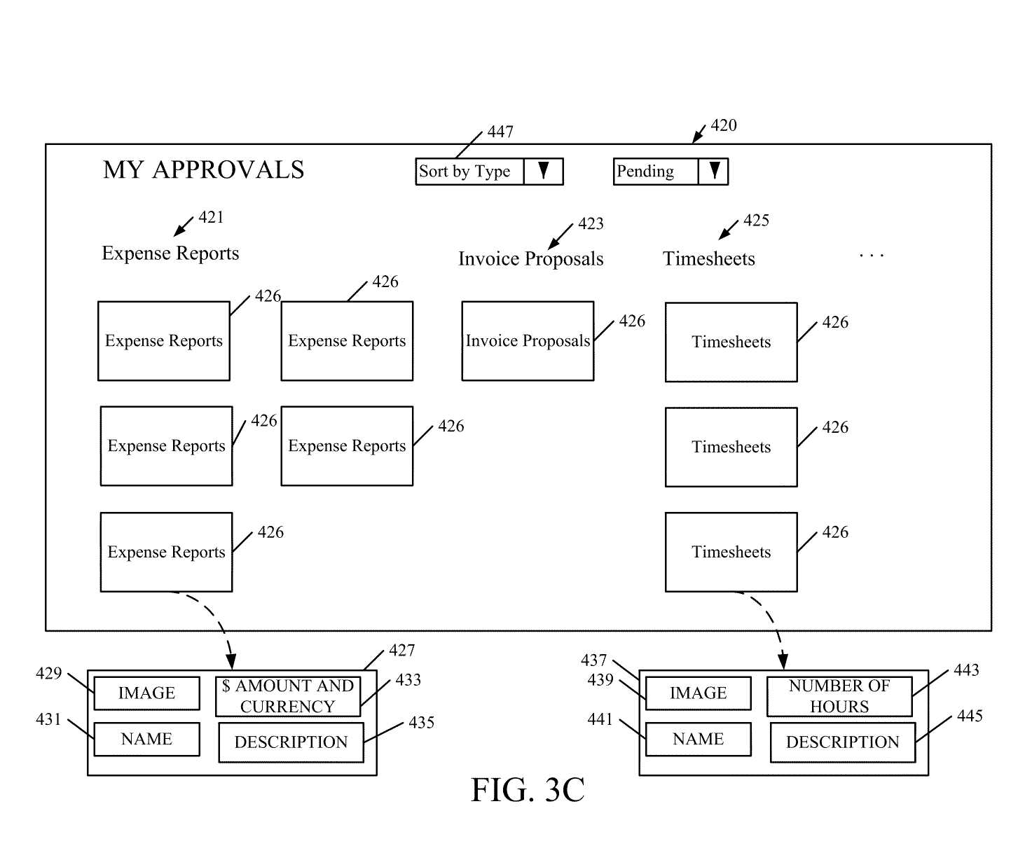

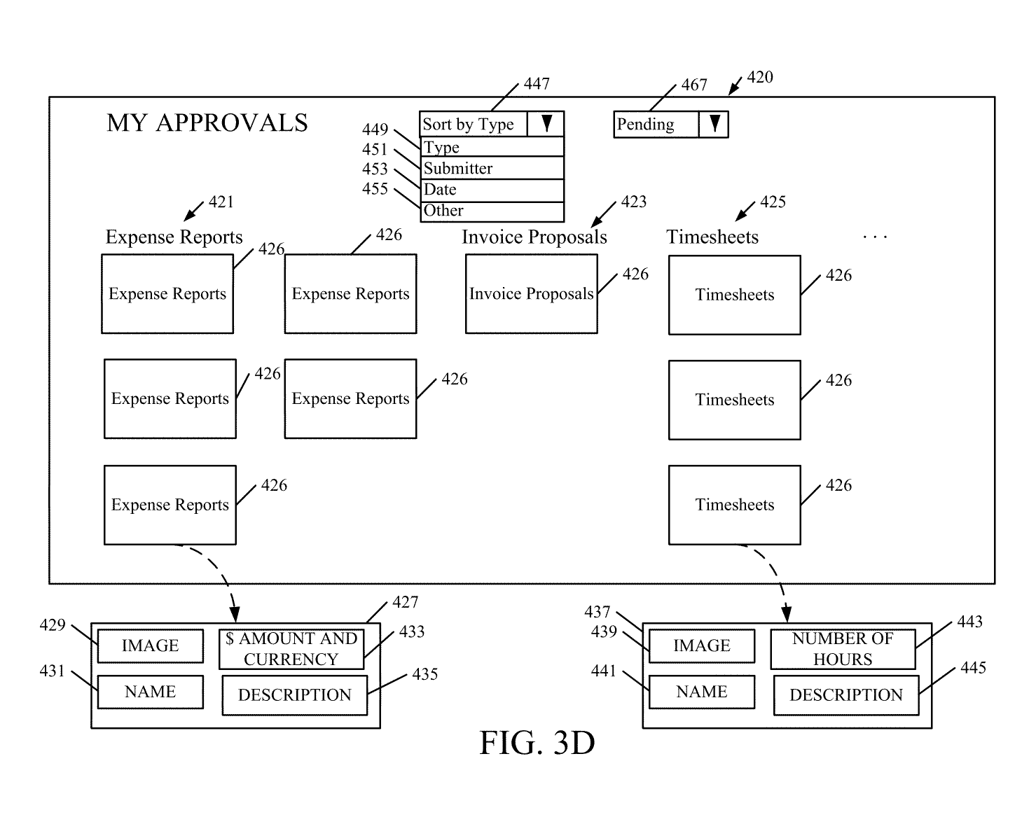

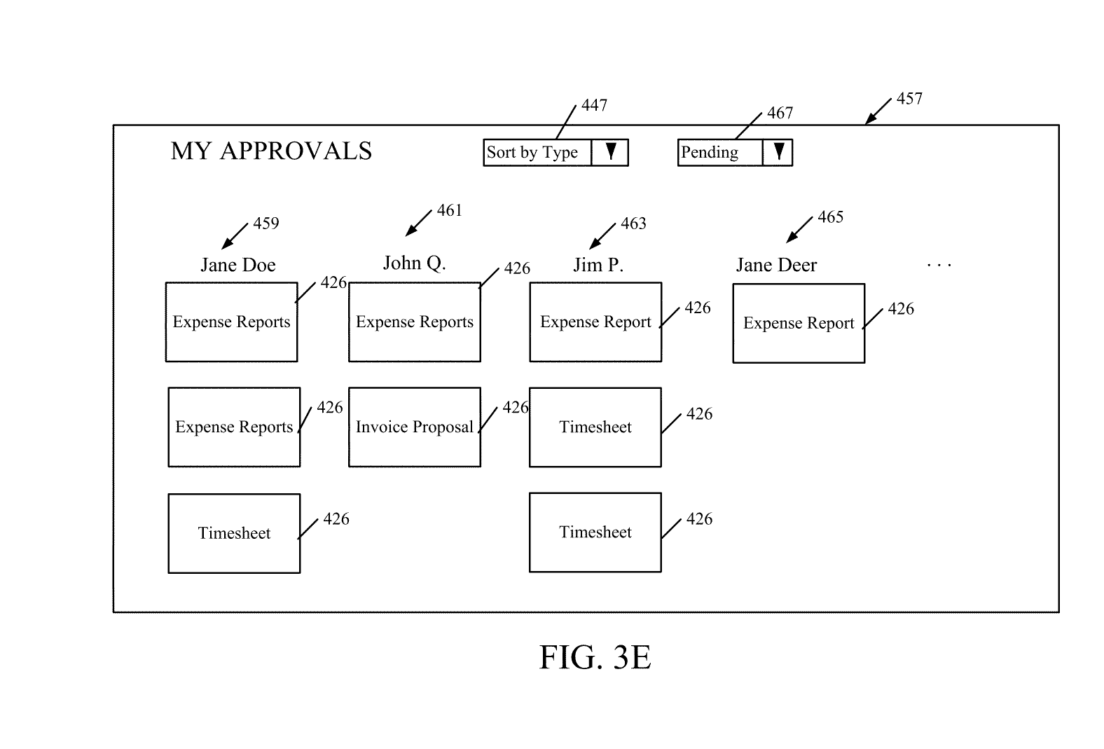

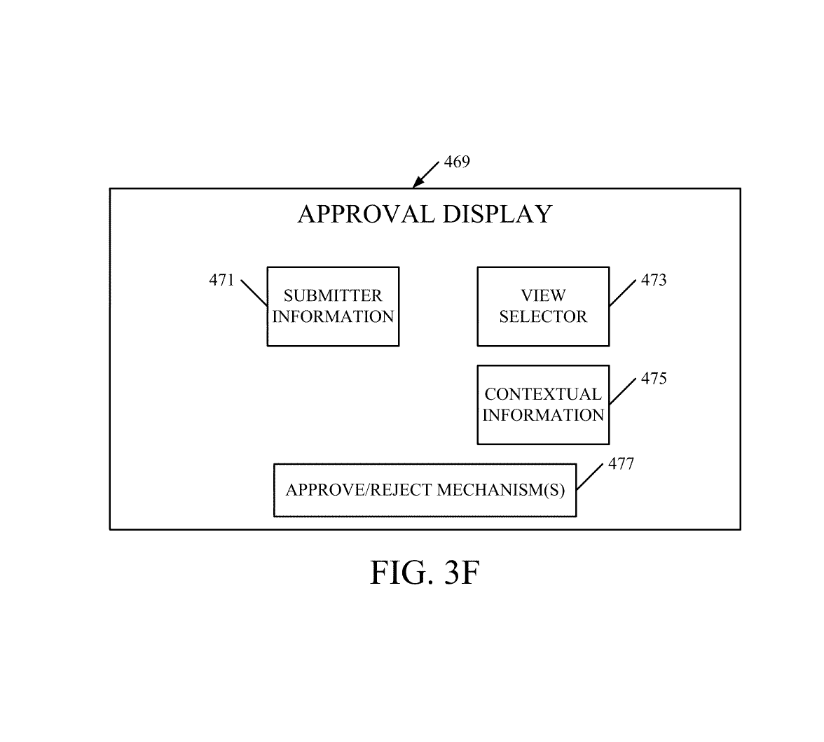

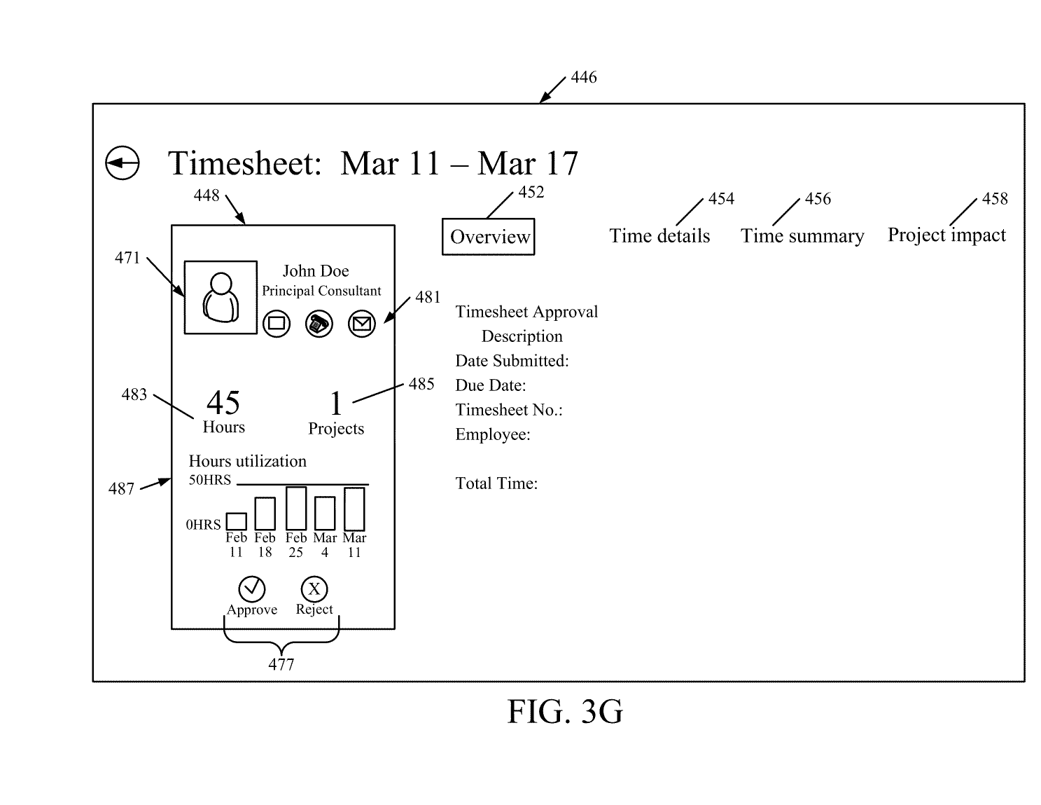

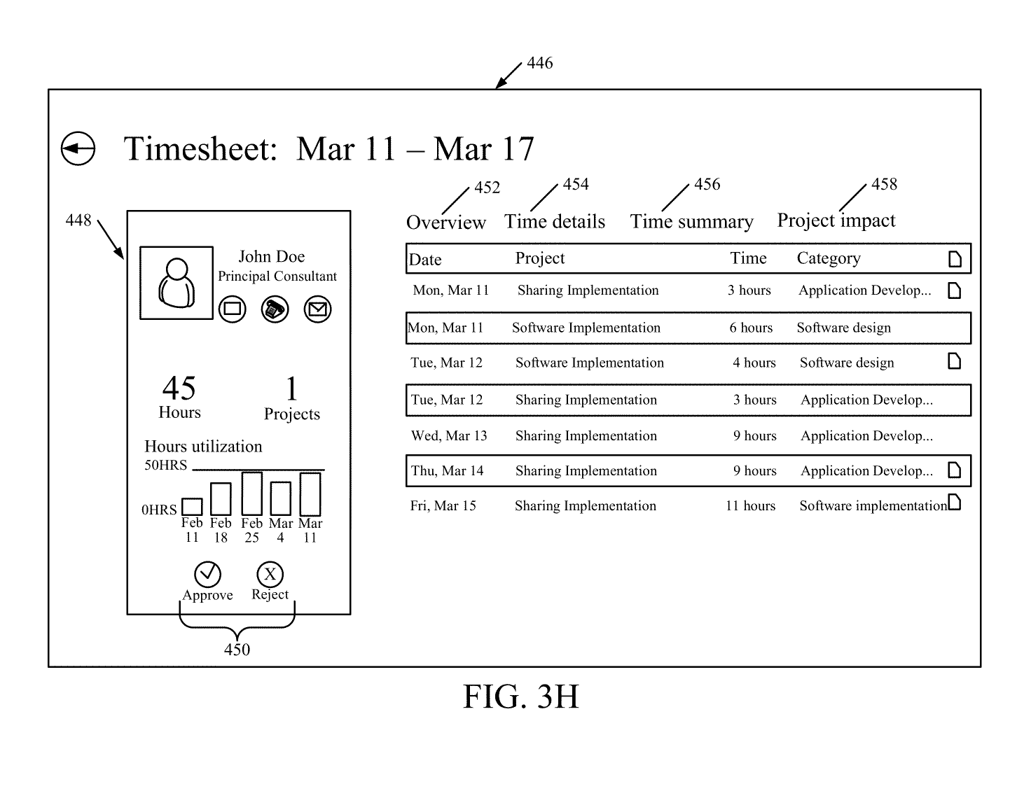

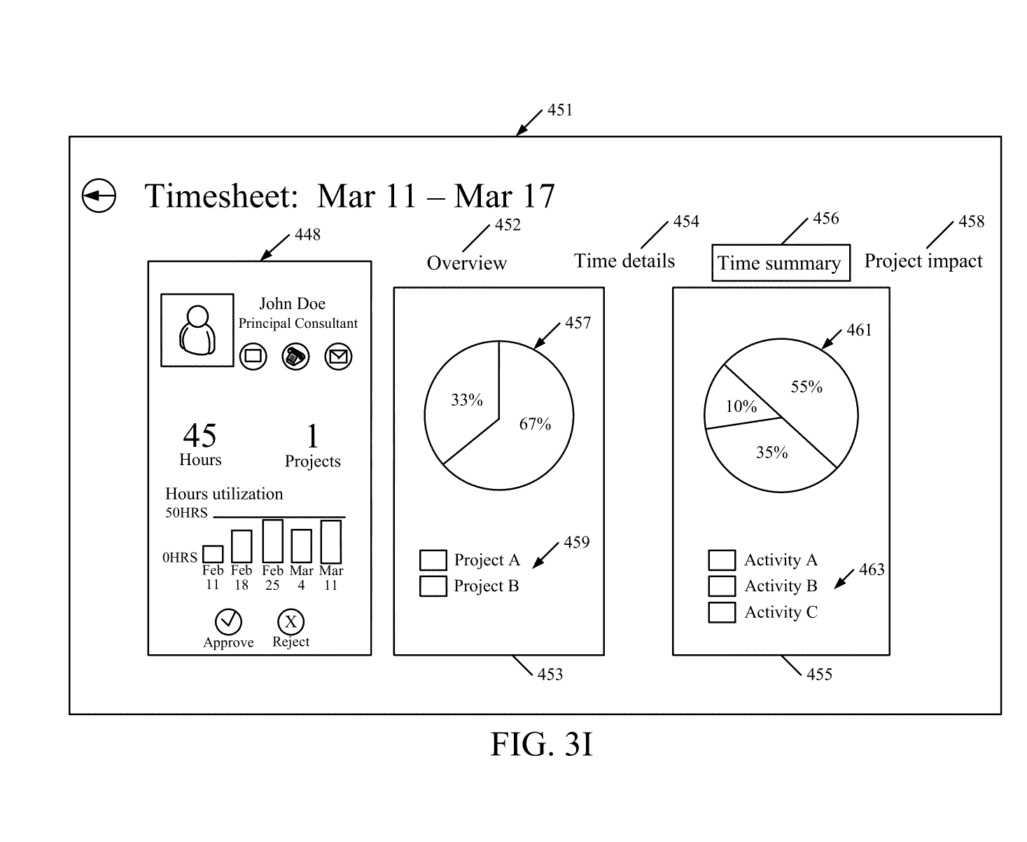

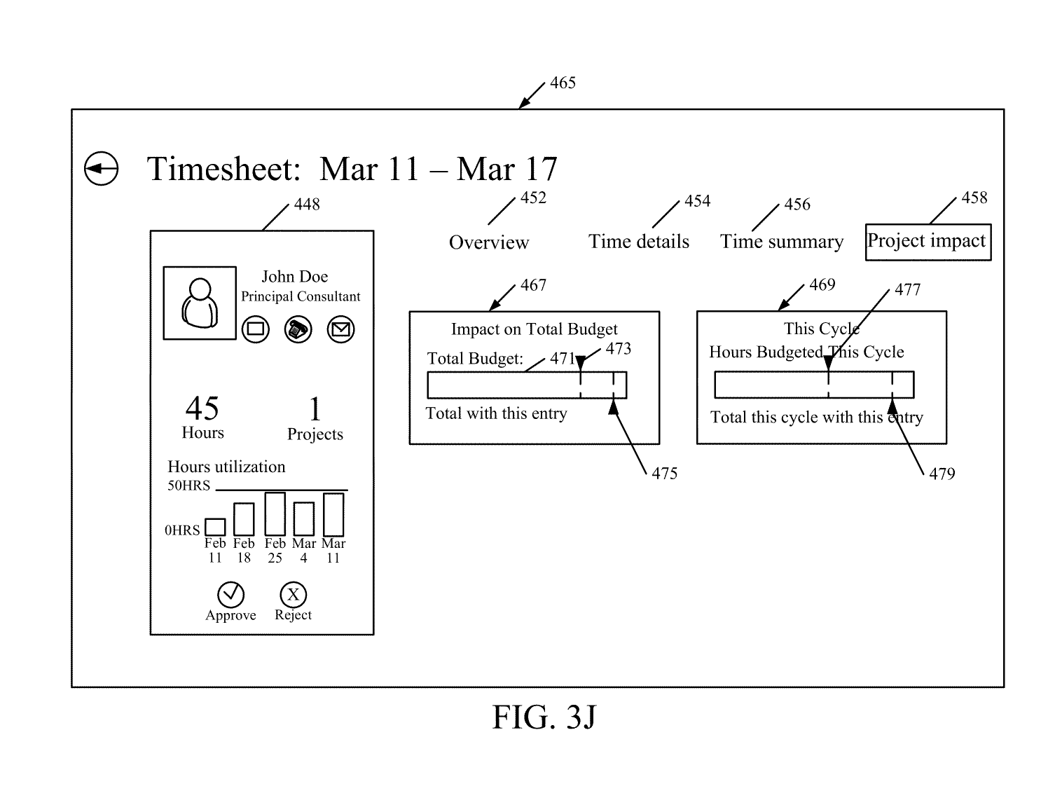

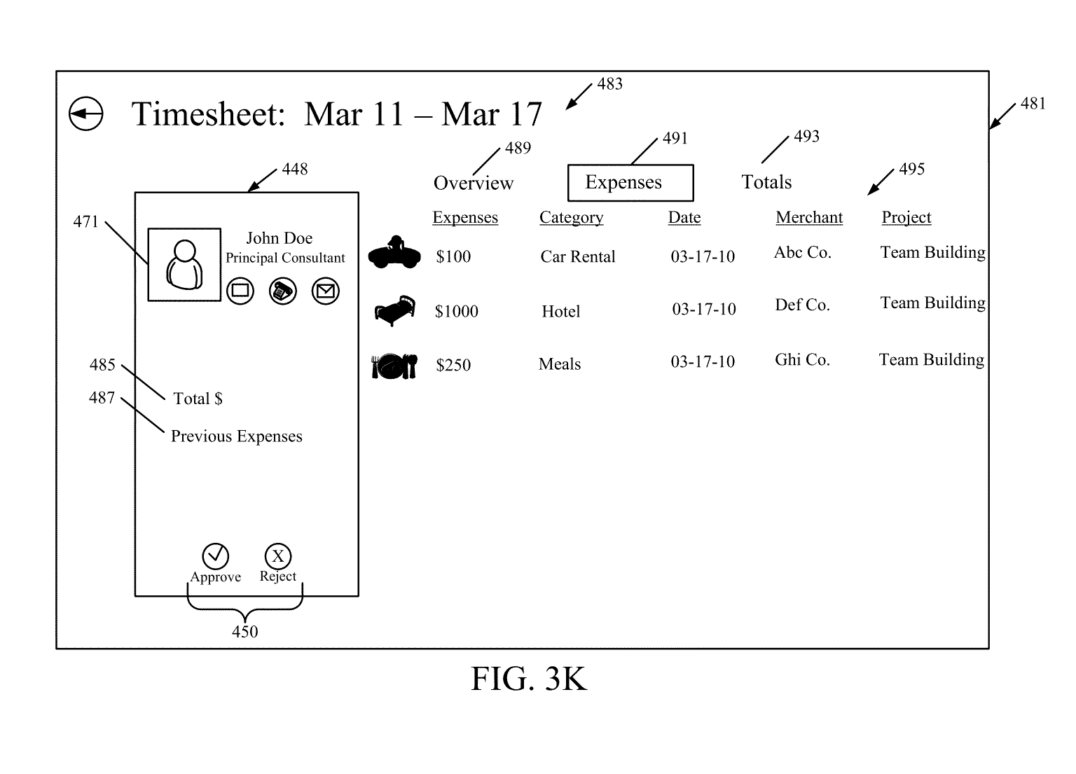

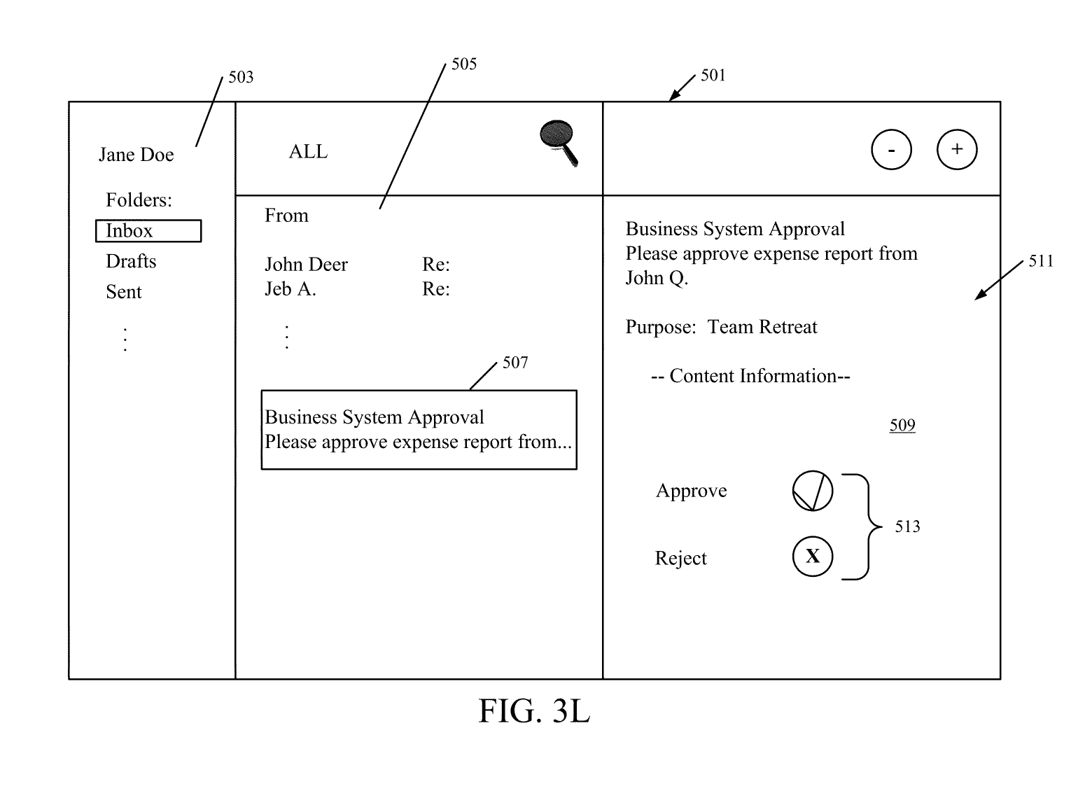

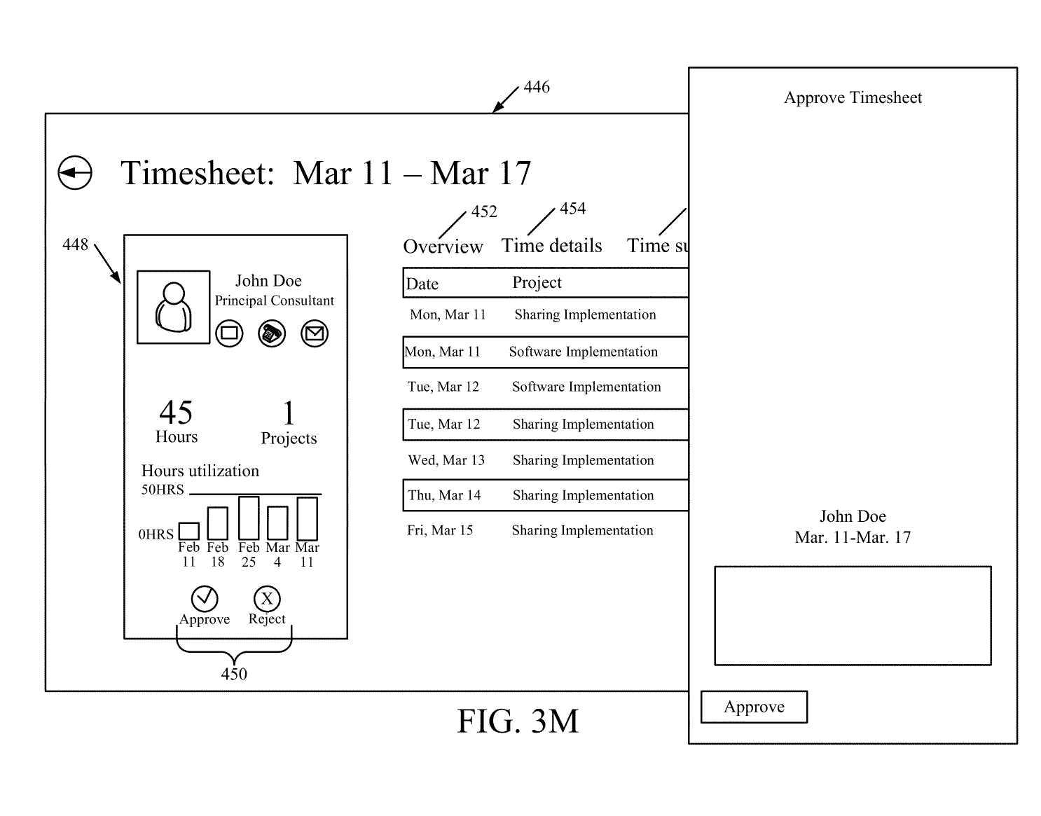

Approval component 126 aggregates approvals from within business system 102 (and from business applications 120), and provides them to a given user 110 for approval by the user 110. By way of example, user 110 may be in a role in the business system 102 such that user 110 must approve expense reports, timesheets, requisitions, customer quotes, or a wide variety of other items. In one embodiment, approval component 126 aggregates all of these approvals, on a user-by-user basis. User 110 can then access approval component 126 to review and approve or reject each of the pending approvals. Approval component 126 is described in greater detail below with respect to FIGS. 3-3M.

FIG. 1 shows that user device 104 includes timesheet management component 130, expense management component 132, approval component 134, processor 136, and user interface component 138. Of course, user device 104 can include other items or components as well. In one embodiment, timesheet management component 130 is a companion application to timesheet management component 122 and interacts with timesheet management component 122 to perform the timesheet management operations. It should be noted, however, that in another embodiment, only a single timesheet management component is used, and it is either located on business system 102 (and accessed by user 110 through user device 104) or it can be located on user device 104, itself, or elsewhere.

Similarly, expense management component 132 is illustratively a companion application to expense management component 124. However, in another embodiment, there is only a single expense management component and it can be located on business system 102 or on user device 104, or elsewhere.

Approval component 134 can also be a companion application to approval component 126. In another embodiment, however, there may be only a single approval component, and it can be located on business system 102 or user device 104, or elsewhere.

Processors 114 and 136 are illustratively computer processors with associated memory and timing circuitry (not separately shown). They are illustratively a functional part of system 102 and device 104, respectively. They are activated by, and facilitate the functionality of, the various components in the system (or on the device) on which they are deployed. While only a single processor is shown on business system 102 and user device 104, it will be noted that multiple processors could be used as well.

User interface components 118 and 138 are illustratively used by other components or items in business system 102, or on user device 104, respectively. User interface components 118 and 138 illustratively generate user interface displays 106 with user input mechanisms 108. Of course, in another embodiment, there is only a single user interface component, and it is deployed either on business system 102 or on user device 104, or elsewhere.

User input mechanisms 108 are used by user 110 to interact with, and manipulate, business system 102. User input mechanisms 108 can illustratively include a wide variety of different types of user input mechanisms. For instance, they can include check boxes, icons, active tiles, text boxes, links, buttons, scroll bars, dropdown menus, etc. In addition, the user input mechanisms 108 can be actuated in a wide variety of different ways. They can be actuated using a point and click device (such as a mouse, a trackball, etc.). In addition, where the user interface display screen that displays user interface displays 106 is a touch sensitive screen, user input mechanisms 108 can be actuated using touch gestures. Further, where user device 104 or business system 102 includes speech recognition components, user input mechanisms 108 can be actuated using voice commands. All of these, and other mechanisms, are contemplated herein.

Business data store 116 illustratively stores business data (such as entities 113, user roles 117 and other data records 119) as well as workflows 115. The entities 113 are illustratively business data records that represent and describe business items. For instance, a customer entity represents and describes a customer. A vendor entity represents and describes a vendor. A product entity represents and describes a product. An inventory entity represents and describes various items of inventory. The workflows 115 are illustratively implemented by business system 102 in order to perform business operations, tasks or activities. Some can be automated while others present user interface displays for user input. Roles 117 are illustratively assigned to users so the users have role-based access to business system 102 in order to perform tasks or activities or operations corresponding to their assigned roles. Data store 116 can include expense items, expense reports and timesheets (or time cards) as well. These are described in greater detail below.

FIG. 1 shows that only a single business data store 116 is used by business system 102, and it is local to business system 102. However, it should be noted that multiple business data stores can be used instead. The business data stores can all be local to business system 102, or they can all be remote from business system 102, or some can be local while others are remote.

FIG. 1A shows one embodiment of a more detailed block diagram of expense management component 124. It can be seen in FIG. 1A that expense management component 124 includes summary generator 200, sort component 202, expense capture component 204, expense reconciliation component 206, view generator 208, drill component 210, submit component 212 and expense editor component 214. Summary generator 200 illustratively generates a summary of expense items and expense reports. Sort component 202 allows user 110 to sort the expense items and expense reports based on different sort criteria. Expense capture component 204 navigates the user to one or more expense capture screens that allow the user to capture an expense item. Expense reconciliation component 206 allows the user to reconcile an expense item to a particular expense report. View generator 208 generates various different types of views of expense reports and expense items. Drill component 210 allows the user to drill down to more detailed information corresponding to an expense report or even an individual expense item. Submit component 212 allows the user to submit an expense report for approval, and expense editor component 214 allows the user to edit expense items or expense reports.

FIG. 1B is a flow diagram illustrating one embodiment of the overall operation of expense management component 124. FIGS. 1B to 1E-1 and 1F-1 to 1G are illustrative user interface displays. FIGS. 1 to 1G will now be described in conjunction with one another.

In order to view or manipulate an expense report, user 110 first accesses business system 102. This can be done in a wide variety of different ways. For instance, in one embodiment, user 110 provides authentication information to business system 102 to “logon” to, or otherwise access, business system 102. User 110 then illustratively navigates through one or more user interface displays to access expense management component 124. For instance, FIG. 1B-1 shows one embodiment of a user interface display 201 that can be generated as a start screen for a user device, an operating system, or another apparatus or a module. The user interface display 201 illustratively has a plurality of actuatable user input mechanisms (such as active tiles, icons, etc.) grouped into groups. The embodiment shown in FIG. 1B-1 includes a frequently accessed group 203, a productivity group 205, a business group 207 and a news and entertainment group 209.

The tiles or icons, when actuated by the user, illustratively navigate the user to a corresponding application. For instance, tiles or icons 211, 213 and 215 in the frequently accessed group 203 illustratively navigate the user (when actuated by the user) to a frequently used application. Tile or icon 211 thus corresponds to a weather application, tile or icon 213 corresponds to a mapping application, and tile or icon 215 corresponds to a video application. The tiles or icons 219 in the productivity group 205 illustratively correspond to a word processing application, a spreadsheet application, a calendar application, and an email application, among others. The tiles or icons 221 in news and entertainment group 209 illustratively correspond to movie applications, news applications, a browser, or other news and entertainment applications. Each tile or icon can illustratively include an image 217 that is representative of the corresponding application. These are exemplary groups and applications and many others can be used.

The business group 207 illustratively includes tiles or icons 223, 225 and 227. Each can include a corresponding image 229 that represents the underlying application. Approvals tile or icon 223, when actuated by user 110, navigates the user to an approvals application, which can be run by approval component 126 shown in FIG. 1. Expense tile or icon 225, when actuated by user 110, illustratively navigates the user to an expense application which may be run by expense management component 124. Timesheet tile or icon 227, when actuated by user 110, illustratively navigates the user to an application run by timesheet management component 122. Of course, there can be other, or different tiles or icons in business group 207, and those shown are shown by way of example only. For the purposes of the present discussion, it is assumed that the user has actuated expense tile or icon 225 and that business system 102 illustratively launches expense management component 124. Accessing and launching expense management component 124 is indicated by block 216 in the flow diagram of FIG. 1B.

Expense management component 124 then illustratively displays a landing page. This is indicated by block 218 in FIG. 1B.

In one embodiment, the expense landing page is illustratively a panoramic view. This is indicated by block 220. More specifically, the landing page is illustratively a horizontally (and, optionally, vertically) scrollable view that allows the user to view and manipulate a variety of different types of expense management information. For instance, the user can illustratively view the number of new expense items 222, the amount of expenses in different states (such as in draft form, in review, rejected, approved, or processed for payment, etc.). Showing the expenses in different states is indicated by block 224 in FIG. 1B. Further, the landing page may illustratively display user input mechanisms (such as icons or tiles) each representative of an expense report and grouped into groups. The groups can be sorted by the state in which the given expense report resides, they can be grouped according to time, etc. This is indicated by block 226 in FIG. 1B. The expense landing page can also include a variety of other information 228 as well.

FIG. 1C shows one embodiment of an expense landing page 230. It can be seen that expense landing page 230 is a panoramic view, in that it is scrollable in the direction generally indicated by arrow 232. It can also be seen that the expense landing page includes a summary portion 233 with a first indicator 234 that indicates the number of new expense items entered or received since user 110 last viewed the expense reports. In addition, the summary portion 233 includes a representation, such as bar chart 236, that shows the amount (in a given currency, such as dollars) of expense items that are currently in different states (such as in draft, in review, rejected, approved, etc.).

As the user scrolls to the right, the user can illustratively actuate an expense reports user input mechanism 238, or an unreconciled user input mechanism 240. When the user actuates mechanism 238, a plurality of different user input mechanisms are displayed, one user input mechanism corresponding to each expense report.

The user input mechanisms are grouped into groups. For instance, they can be grouped by state (such as expense reports that are in draft form, in review, rejected, approved, etc.), they can be grouped by time, or according to other group criteria. In the embodiment illustrated in FIG. 1C, it can be seen that the user input mechanisms that represent expense reports are icons (or tiles) 242 and 244, and both expense reports are grouped into a draft group indicating that they are currently being drafted by user 110.

Also, FIG. 1C shows user input mechanism 246 that allows a user to generate a new expense report. When the user actuates mechanism 246, the user is navigated to one or more report creation screens that allow the user to generate a new expense report.

As the user scrolls to the right in FIG. 1C, as indicated by arrow 232, other icons or tiles indicative of other, already existing, expense reports are illustratively displayed according to other groups as well. FIG. 1C-1 shows one example of a user interface display showing expense landing page 230 after it has been scrolled to the right by user 110. Similar items to those shown in FIG. 1C are similarly numbered. FIG. 1C-1 shows that the user has actuated expense report button 238 so that tiles 242 each correspond to an expense report in one of a variety of different states.

Referring again to the flow diagram of FIG. 1B, the user then illustratively interacts with the landing page 230. This is indicated by block 350. For instance, the user can change the sort criteria so that the icons or tiles that represent the expense reports are sorted into different groups, based on the new sort criteria. This is indicated by block 252. In addition, the user can actuate one of the expense report tiles or icons 242 or 244 to view more detailed information, and this is indicated by block 254. The user can also actuate unreconciled actuator 240 to view unreconciled expense items. This is indicated by block 256. The user can also actuate a user input mechanism indicating that the user wishes to enter (or capture) another expense item, or to create a new expense report. This is indicated by block 258. The user can also perform other interactions as indicated by block 260.

Once the user has interacted with landing page 230, expense management component 124 performs one or more actions based upon the user interaction. This is indicated by block 262.

As some examples, component 124 can illustratively re-sort the expense reports (e.g., the tiles or icons representing the expense reports) according to other sort criteria specified by user 110. This is indicated by block 264 in FIG. 1B. The user can also open an expense report and view generator 208 can provide various view options or interaction options that allow the user to interact with the opened expense report. This is indicated by block 266. The user can show unreconciled expense items with mechanisms that allow user 110 to add them to an expense report. This is indicated by block 268. Expense management component 124 can also navigate the user to a set of capture interfaces (or to a capture user experience) that allows the user to capture a new expense item or generate a new expense report. This is indicated by block 270. Component 124 can also submit an expense report for approval as indicated by block 271. Of course, the expense management component 124 can take other actions as well and this is indicated by block 272.

FIG. 1C-1 shows that user 110 has actuated expense reports mechanism 238. Therefore, each of tiles or icons 242 corresponds to a separate expense report. It can also be seen in FIG. 1C-1 that the user has used sort criteria selector 231 and selected “state”. Therefore, it can be seen that each of the tiles or icons 242 is sorted into a group in the display of FIG. 1C-1 based upon the state in which the corresponding expense report resides. FIG. 1C-1 shows four different states. The first state is the draft state 233. The second state is the in review state 235. The third state is the approved state 237, and the fourth state is the processed for payment state 239. Of course, it will be understood that these are exemplary states and other states could be used as well. However, for the sake of the example shown in FIG. 1C-1 each state 233, 235, 237 and 239 has one or more tiles or icons 242. Therefore, it can be seen that there are one or more expense reports in the draft state, in the review state, in the approved state, and in the processed for payment state.

It will be noted that user 110 can also actuate sort criteria mechanism 231 and select different sort criteria, such as date, project, etc. In that case, sort component 202 (shown in FIG. 1A) re-sorts the tiles or icons 242 and groups them into other groups on the display, based on the new sort criteria. More embodiments of this are discussed in greater detail below.

FIG. 1C-2 shows one embodiment of a user interface display 241 in which the user has actuated unreconciled user input mechanism 240, instead of expense report user input mechanisms 238. In that case, view generator 208 shows a plurality of different tiles or icons 280 that each correspond to an expense item. It can be seen that the user has actuated sort criteria actuator 231 to indicate that the tiles or icons should be sorted by category. Therefore, all unreconciled expense items (which have not yet been reconciled to an expense report) have a corresponding tile that this sorted into the various categories (such as an entertainment category, a flight category, a hotel category, etc.).

It can be seen that the first category is referred to as the “uncategorized” expense items. Thus, all expense items that have not yet been placed in a category by user 110 will have an icon or tile 280 that represents the expense item, and that it is placed in the uncategorized category in FIG. 1C-2.

If the user again actuates the sort criteria input mechanism 231, the user can choose other sort criteria as well. In one embodiment, the unreconciled expense items can be sorted by source. That is, they can be sorted by how they are input into the system. For instance, all of the expense items that were captured using the user's smart phone can be categorized into one group. Similarly, those captured from a credit card receipt can be placed in another group, etc.

Upon reviewing all of the unreconciled expense items, it may be that user 110 wishes to reconcile one or more of the expense items to a new or pre-existing expense report. In that case, the user illustratively selects the tile or icon 280 associated with the particular expense item to be reconciled to an expense report. It can be seen that the user has selected the expense item corresponding to tile or icon 281, and thus a check mark 283 appears on the tile or icon 281 to indicate that it has been selected. As soon as the user selects the tile, a more detailed display 279 is shown. Detail display 279 shows more detailed information corresponding to the expense item represented by the selected icon or tile 281. It can be seen in the embodiment shown in FIG. 1C-2 that detail display 279 shows the total amount 289 of the expense item, as well as a variety of different kinds of detail information 291, such as the category, merchant, transaction date, transaction amount, transaction source, and notes. These are exemplary only. In addition, where the user has captured an image of a receipt corresponding to the expense item, details display 279 illustratively shows a thumbnail 293 of that image. When the user actuates the image (such as by clicking on the thumbnail or touching it using a touch gesture) a larger representation of the image is illustratively displayed so that the user can read the receipt or other items in the image.

The user can reconcile the selected expense item to a new expense report by actuating a user input mechanism, such as actuator 285, which allows the user to create a new expense report and assign the selected tile or icon (corresponding to the underlying expense item) to that new expense report. The user can also actuate a user input mechanism, such as mechanism 287, to reconcile the expense item to an existing expense report.

When the user actuates the new expense report actuator 285, the user is illustratively provided with a user interface display such as that shown in FIG. 1C-3. It is similar to that shown in FIG. 1C-2, except that a new expense report display 295 is shown. The new expense report display 295 allows the user to input information in order to create a new expense report. For instance, the user can input the purpose of the expense report, the location, and add notes to the expense report. The user can also assign the expense report to a project, if desired. These are given by way of example.

Referring again to FIGS. 1C-2 and 1C-3, the user can also select the tile or icon that represents an expense item and edit it, such as by modifying or deleting details, or by adding more details to it. For instance, if the user double clicks or otherwise actuates an expense item and provides a user input to indicate that the user wishes to add extra details or provides a user input indicating that the user wishes to edit the information corresponding to the underlying expense item, a display such as display 301 shown in FIG. 1C-4 is generated. Display 301 includes an expenses pane 303 and a details pane 305. The tiles or icons 280 corresponding to the underlying expense items are shown in pane 303, along with an add tile or icon 246 that allows the user to add another expense item. When the user selects one of the tiles or icons 280 in pane 303 (which can be indicated by a check mark 307) the information in the details pane 305 is updated to show all the detail information that has already been input for the selected expense item. In the embodiment shown in FIG. 1C-4, details pane 305 allows the user to add information corresponding to a category, date, merchant, payment method, amount, currency, receipts, project, activity number, city, zip or postal code, additional information and other information. Of course, this shows exemplary detail information and other information could be used as well.

In one embodiment, the expenses pane 303 is illustratively scrollable. Therefore, as the user scrolls vertically in pane 303, the additional expense items that are being viewed will be represented by icons or tiles in pane 303. When the user selects one of them, the information in details pane 305 is updated to the corresponding detail information.

Returning again to FIGS. 1C and 1C-1 (which show the expense landing page 230), assume the user actuates a tile or icon 242 corresponding to an already-existing expense report. FIG. 1D shows one illustrative user interface display 274 that is generated when the user actuates a tile or icon 242 (from FIG. 1C or 1C-1) corresponding to a given expense report on landing page 230. It can be seen that drill component 210 responds to this by displaying more detailed information for the given expense report. Display 274 illustratively includes a new expense actuator 276 which, when actuated by user 110, allows the user to capture a new expense item. This is described in greater detail below. The display 274 also includes sort actuator 278 that allows the user to sort the expense items on the currently-displayed expense report based on various sort criteria. In the embodiment shown, each expense item is represented by an icon or tile 280. The tiles or icons are sorted into groups based on the category in which they reside. For example, the expense items that are listed in FIG. 1D are sorted into a car rental group, an entertainment group, a flight group, a hotel group, a meal group, etc. Each group can also be individually scrollable in the vertical direction to show additional tiles representing additional expense items in that group. When the user actuates one of the tiles, the drill component 210 opens up that expense item and displays even more detailed information corresponding to the given expense item, such as the details shown above in FIG. 1C-4.

FIG. 1E shows another user interface display 282. Display 282 shows that the user has actuated the sort actuator 278 and selected the calendar sort criteria. This causes sort component 202 in expense management component 124 to sort the various expense items in the present expense report based on the calendar criteria 284. Therefore, display 282 includes a calendar or timeline 286 and displays the tiles or icons corresponding to the various expense items sorted by date. In one embodiment, the display 282 also includes a summary bar 288 that includes summaries of the amounts in the expense items, indicating how they have been accounted for. The user can submit the expense report for approval by activating the submit actuator 401 in the application bar.

FIG. 1E-1 shows one embodiment of user interface display 282 that is generated by submit component 212 when the user actuates submit actuator 401. A summary view 283 is illustratively generated. Summary view 283 can show a summary of the expenses in the expense report in a variety of different ways. In the example in FIG. 1E-1, summary view 283 includes a pie chart and a key that breaks down the total expenses on the report by category (e.g., meals, hotels, taxi, etc.). The chart can be color coded or otherwise visually displayed to show the categories. Also, the expenses can be summarized in other ways (such as by date, by project, etc.) and shown using other displays other than a chart. The display shown in FIG. 1E-1 is exemplary only.

FIG. 1F is a flow diagram showing one embodiment of the operation of expense management component 124 in capturing and reconciling an expense item to an expense report. FIGS. 1F-1 to 1G show different user interface displays that allow user 110 to capture a new expense item from a mobile device, such as from a mobile phone. FIGS. 1F to 1G will now be described in conjunction with one another.

In order to capture an expense item, the user first actuates a user input mechanism to add an expense item (such as user input mechanism 246 in FIG. 1C-4 or user input mechanism 276 in FIG. 1E). This is indicated by block 315 in FIG. 1F. In response, expense capture component 204 (shown in expense management component 124 in FIG. 1A) generates an expense item details display that includes user input mechanisms so that the user can input details for the expense item. Displaying the expense item details display is indicated by block 317 in FIG. 1F.

Of course, there are a wide variety of different types of details that the user can input, and some of those include the merchant 319 to which the expense was made, the date 321, the amount of the expense 323, the currency 325, the category (such as taxi, meals, hotel, etc.) 327, an image corresponding to the expense item (such as an image of a receipt or another image) 329, notes 331, or other information 333. FIG. 1F-1 shows one embodiment of a user interface display 290 that allows the user to enter details for a new expense item.

It can be seen in FIG. 1F-1 that there are a plurality of different fields corresponding to the different details. The user can illustratively enter the detail information into the fields in a variety of different ways, such as by touching or otherwise actuating one of the fields. This can be done using touch gestures, using a keypad, using buttons, or any other desired user mechanisms. In the embodiment shown in FIG. F1-1, it can be seen that the user has already entered a variety of different information. In one embodiment, when the user touches one of the fields shown in FIG. 1F-1, a keyboard or keypad is displayed that allows the user to enter alpha numeric information. For instance, with reference to FIG. 1F-1, assume that the user has touched field 335 corresponding to the “amount” detail. In that case, expense capture component 204 illustratively generates a display such as that shown in FIG. 1F-2, in which a numeric keypad 337 is displayed. This allows the user to enter the amount (in this case $45) into field 335.

It will be noted that a variety of different types of user input mechanisms (or displays) can be generated based upon the particular user input mechanism that the user has actuated. For instance, again referring to FIG. 1F-1, assume that the user has now actuated the date field 339. In that case, expense capture component 204 illustratively generates a user interface display with user input mechanisms that allow the user to easily enter a date. FIG. 1F-3 shows one embodiment of user interface display 290, except that instead of a keypad, a date input mechanism 341 is displayed. The date input mechanism 341 illustratively includes a touch sensitive field corresponding to the month, the day and the year. When the user actuates one of those fields (such as by touching it), an entry mechanism appears and allows the user to easily enter the desired information. This can be done, again, using a keyboard, a keypad, or other user input mechanisms. By way of example, it can be seen in FIG. 1F-3 that the user has actuated the field 343 corresponding to the day. This causes a scrollable user input mechanism to appear in which the user can scroll to previous days or subsequent days by scrolling the display in the direction indicated by arrow 345. For instance, if the user scrolls downward, the days move backward in time. However, if the user scrolls upward, the days move forward in time. This same type of user input mechanism can be used for the month and the year as well, although different user input mechanisms can also be used.

Referring again to FIG. 1F-1, the user can illustratively capture an image corresponding to the newly created expense item by either actuating the image field 347 or by actuating a camera (or other image capture) user input mechanism 349. When the user does this, expense capture component 204 illustratively enables the camera (or other image capture) function and generates a display, such as display 291 shown in FIG. 1F-4. It can be seen that display 291 includes an image pane 351 that shows the camera view (such as when looking through a camera view finder using the camera function). When the user is satisfied that the receipt (or other item for which an image is being captured) is adequately displayed in pane 351, the user can illustratively actuate the camera button 349, again, to capture the image. The user can then review the image, as it was captured, in pane 351 and either actuate the accept button 353 or the retake button 355. If the user accepts the image, then the image is automatically attached by expense capture component 304 to the newly created expense item, so that whenever the user pulls that expense item up for later review, the captured image will be available for viewing along with the captured expense item.

By way of example, when the expense management component displays an expense icon or tile that has an associated image, a visual indication can be provided indicating that there is an attached image. When the user actuates the icon or tile for the expense item, a thumbnail of the image can be displayed along with the more detailed information for that expense item. If the user actuates the thumbnail, the image can be enlarged and viewed by the user. It will also be noted that the thumbnail of the image can be attached and displayed along with the icon or tile corresponding to the expense item as well. These are some exemplary embodiments of how the image can be attached to or otherwise associated with an expense item.

When the user actuates the accept button 353, expense capture component 204 also illustratively generates another display, such as the display shown in FIG. 1F-5. It can be seen that the new expense item now includes all the detailed information previously input by the user, as well as an image display pane 357 that displays the image 359 that was just captured and associated with the newly created expense item.

FIG. 1G shows another embodiment of a user interface display 292 that displays a variety of fields, in a somewhat different layout from that shown in FIG. 1F-1. The user can actuate the fields (such as with touch gestures or otherwise) or actuate other user interface elements (such as the buttons or other elements on display 292) to input the detailed information.

Receiving the user inputs for the details corresponding to an expense item is indicated by block 361 in FIG. 1F. Expense capture component 204 then generates a visual representation of the expense item with summary data that is extracted from the details entered by the user. This is indicated by block 363 in FIG. 1F. For instance, as discussed above, the expense capture component 204 can generate an icon or tile representing the expense item that shows the amount 323, the currency 325, the expense category 327, the date 321 or any other information 333. These are examples only.

Once the new expense item has been captured, it is illustratively added to the expense management application (such as by storing it in the business data store 116 or another place where it can be accessed by the expense management application) where it can be manipulated by the user. For instance, when the visual representation of the expense item is displayed, the user can actuate that visual representation (e.g., the icon or tile). This is indicated by block 365 in FIG. 1F. In response, drill component 210 illustratively displays the detailed information corresponding to that expense item. This is indicated by block 367.

If the expense item is not yet reconciled to an expense report, expense reconciliation component 206 illustratively receives user reconciliation inputs. This is indicated by block 369. The reconciliation inputs can identify a given expense item as indicated by block 371 and a given expense report as indicated by block 373, and any other desired information 375. As discussed above with respect to FIGS. 1C-2 and 1C-3, expense reconciliation component 206 then illustratively reconciles the identified expense item to the identified expense report. This is indicated by block 377. As also discussed above, the expense report can be either an already-existing expense report, or one that is newly created by the user. In any case, the expense item is illustratively reconciled to an expense report within the expense management application in business system 102.

FIG. 2 is a more detailed block diagram of one embodiment of timesheet management component 122. FIG. 2 shows that timesheet management component 122 includes summary component 300, sort component 302, timesheet capture component 304, view generator 306, drill component 308 and timesheet editor component 310. Summary component 300 illustratively summarizes various data corresponding to timesheets. Sort component 302 sorts timesheets by different sort criteria so that it can be displayed according to those criteria. Timesheet capture component 304 illustratively allows user 110 to create a new timesheet and to enter time on a new or existing timesheet. View generator 306 generates various views for user 110, in order to view timesheets and time entries in different ways. Drill component 308 allows user 110 to drill down to more detailed information corresponding to a given timesheet, or timesheet entry. Timesheet editor component 310 illustratively allows user 110 to edit timesheets or timesheet entries.

FIG. 2A is a flow diagram showing one illustrative embodiment of the operation of timesheet management component 122. User 110 first accesses and launches time sheet management component 122. This can be done such as by actuating user interface element 227 (in FIG. 1B-1) and is indicated by block 312 in FIG. 2A.

In response, timesheet management component 300 displays a landing page. This is indicated by block 314. The landing page is illustratively a panoramic view 316, in that it can be horizontally (and optionally, vertically) scrolled. The panoramic view 316 illustratively presents a variety of different information corresponding to different timesheets entered by user 110. For instance, it can indicate the overall number of timesheets that are currently in review, as indicated by block 318. It can also provide a summary of time entered on timesheets over previous time periods. This is indicated by block 320. It can also generate visual representations of timesheets grouped into groups (such as by state, date, or according to other sort criteria). This is indicated by block 322. The landing page can of course display other information as well, as indicated by block 324.

FIG. 2B shows one embodiment of a part of a landing page 326. Page 326 is panoramic in that it is scrollable in the directions indicated by arrow 328. It can also, optionally, be scrollable in the vertical direction as well. It illustratively includes a first indicator 330 that shows the number of timesheets that are currently in review. The embodiment shown in FIG. 2B also shows a bar chart 332 that shows time entered on timesheets for previous timesheet periods. In one embodiment, the timesheet period is set within business system 102. For instance, it can be set for a week, two weeks, etc. In any case, the bar chart 332 illustratively shows time entered according to previous time periods.

As the user scrolls to the right, display 326 illustratively includes an icon or link 334 that allows the user to generate a new timesheet. When the user actuates icon or tile 334, the user is navigated to a user experience in which the user can create a new timesheet. Display 326 also illustratively includes icons or tiles 336 and 338 that correspond to different, already existing, timesheets.

As the user scrolls to the right, the user can see additional icons or tiles 501-515 that also correspond to different timesheets. It can be seen that the timesheets are sorted by sort component t302 (shown in FIG. 2) into groups, and some groups includes Draft group 340, Rejected group 517, In Review group 519 and Approved group 521. These groups are exemplary only. Each group illustratively includes a tile or icon for each timesheet that is currently in the status (or state) represented by that group. Of course, as the user scrolls to the right on display 326, the display may illustratively include tiles or icons corresponding to timesheets in different groups as well.

In addition, display 326 includes sort criteria selector (or mechanism) 523. In the embodiment shown in FIG. 2B-1, selector 523 is a drop down menu, but it can be other user input mechanisms that allow the user to specify different sort criteria. In the embodiment shown, when the user actuates mechanism 523, the user can choose to have the icons or tiles sorted into groups by state or date. These are exemplary criteria and others could be used.

The user 110 then illustratively interacts with landing page 326. This is indicated by block 342 in the flow diagram of FIG. 2A. For instance, the user can change the sort criteria as indicated by block 344 (and as described above) or actuate one of the timesheet icons or tiles as indicated by block 346. The user can also generate a new timesheet by actuating icon or tile 334. This is indicated by block 348 in the flow diagram of FIG. 2A. The user can of course interact in other ways as well, as indicated by block 350.

Timesheet management component 122 then performs one or more actions based upon the user interaction with landing page 326. This is indicated by block 352 in FIG. 2A. For instance, where the user changes the sort criteria, sort component 302 sorts the timesheets based on the new criteria and displays the icons or tiles sorted into different groups. This is indicated by block 354 in FIG. 2A. Also, where the user actuates one of the timesheet tiles or icons on the landing page 326, drill component 308 illustratively presents more detailed information for the corresponding timesheet, including mechanisms that allow the user to enter additional time entries (or capture additional time entries). This is indicated by block 356. Where the user actuates icon or tile 334 to create a new timesheet, timesheet editor component 310 illustratively allows the user to create and edit a new timesheet. This is indicated by block 358. The user can also control component 122 to submit a timesheet for approval as indicated by block 359. Where the user performs other interactions with landing page 326, timesheet management component 122 performs other actions as well, and this indicated by block 360.

FIG. 2C shows one embodiment of a time period view 362 of a timesheet. That is, user 110 has actuated one of the tiles or icons corresponding to a timesheet, on the landing page 326. Drill component 308 thus generates a more detailed view of the corresponding timesheet. It can be seen that the view 362 includes a week actuator (or time period actuator) 364, a details actuator 366 and a charts actuator 368. The user has actuated the week actuator 364 which displays the timesheet for a given week.

Each entry includes a visual indicator 372 corresponding to each time entry on the timesheet. The visual indicator describes the time entry and indicates a total amount of time that has been entered by the user in that time entry. In one embodiment, time entries on the same day or on the same display are illustratively color coded (or otherwise visually coded or visually distinguished) to indicate various things. For instance, they can be color coded to indicate entries for different projects, for billable versus non-billable time, or to indicate other things as well.

Display 362 also includes a totals bar 374 that indicates a total amount of time billed on each day in the time period. Further, display 362 illustratively includes a summary bar 376 that summarizes information for the display 362. In the embodiment shown in FIG. 2C, summary bar 376 includes a total hours number, a billable hours number, a non-billable hours number and a status indicator indicating the status or state of the corresponding timesheet.

Each day in the week includes an add button 370. When the user actuates an add button 370, the user can enter a new timesheet entry on the day corresponding to the actuated add button 370. FIG. 2C-1 shows one embodiment of user interface display 362 when the user has actuated one of the add buttons 370. This navigates the user to a user interface display that allows the user to create a new entry. An edit panel 531 is displayed. In one embodiment, edit panel 531 slides out into display 362 from the right hand side of the display. Of course, this is exemplary only. Edit panel 531 includes a plurality of different fields or user input mechanisms that allow the user to define and enter a new time entry. The user can enter the hours, the date, the legal entity, the project, the category, the activity, the line property, internal notes, external notes, etc. In one embodiment, the fields are user input mechanisms so that when the user touches one of the fields or otherwise actuates it, a keyboard or keypad appears allowing the user to enter alphanumerical or other information. In another embodiment, the user input mechanisms can be dropdown menus or other user input mechanisms that allow the user to enter information. The user can add the time entry the timesheet being displayed by actuating create button 533. When this happens, the user interface display 362 is updated so that the new time entry appears on the appropriate date in the timesheet being displayed.

When the user actuates details actuator 366, drill component 308 illustratively shows more details corresponding to the timesheet. This can be shown in a list view or a tabular view, or in any other desired view. For example, FIG. 2C-2 shows a user interface display 535 that can be displayed when the user has actuated the “details” actuator 366. Display 535 shows the details view in tabular form by displaying a table 537 that lists a variety of details for each time entry on the timesheet being displayed. It be seen that the details include the date, the legal entity, the project, the category, activity and the hours, as well as the charge code for each time entry. The example shown in FIG. 2C-2 also indicates that each entry includes a notes actuator 539. When the user actuates notes actuator 539, the user can see the internal, external, or both internal and external notes entered for the time entry. It can also be seen that each time entry has a separate line. Therefore, for instance, because the timesheet has two different time entries on March 12, there are two different lines in table 537 for that date.

When the user actuates charts actuator 368, view generator 306 illustratively generates a pie chart (or any other desired chart) view showing the total amount of time billed by a user for this pay period (e.g., corresponding to this timesheet) in proportionate parts of the chart, and divided out as desired (such as per project, billable versus non-billable time, etc.). For instance, FIG. 2C-3 shows one embodiment of a user interface display 541 that can be generated when the user actuates the charts actuator 368. In the embodiment shown in FIG. 2C-3, the displayed charts include a projects chart 543 that shows the proportionate amount of time billed on this timesheet for the two different projects. A key portion 545 visually indicates which portions of the pie chart 543 correspond to which project. Category chart 547 is also a pie chart showing the proportionate amount of time, in this timesheet, devoted to different categories. Again, a key portion 549 visually indicates which parts of chart 547 correspond to which different categories. Of course, the charts shown in FIG. 2C-3 are exemplary only.

FIG. 2D shows one embodiment of a timesheet user interface display 551 on a mobile device (such as a smart phone). The user interface display 551 includes new time entry user input mechanism 553, a current time period user input mechanism 555, a previous time period user input mechanism 557 and a projects user input mechanism 559. When the user actuates mechanism 553, the user is navigated to a user experience that allows the user to make a new time entry on either a new timesheet or a pre-existing timesheet. When the user actuates user input mechanism 555, the user is shown a user interface display that represents the timesheet for the current time period. When the user actuates user input mechanism 557, the user is shown a display that represents the timesheet for the immediately previous time period, and when the user actuates user input mechanism 559, the user is shown a display that represents information regarding the various projects that the user is currently working on.

FIG. 2D-1 shows user interface display 392 which is generated when the user actuates current period user input mechanism 555. It can be seen that FIG. 2D-1 shows a timesheet user interface display 392 that shows all of the dates during the current time period (for which the present timesheet is being generated) and time entries 561, 563 and 565 that have been entered on some of those dates. Each day in the date range 388 includes an indicator that shows time entries made on that date. The status and total hours for the period are indicated generally at 390.

Display 392 also includes a plurality of different view selectors. For instance, user input mechanism 567 corresponds to a calendar view. It can be seen in FIG. 2D-1 that the user has actuated user input mechanism 567 so that the current timesheet is displayed as the calendar view shown in FIG. 2D-1. However, display 392 also illustratively includes a summary actuator 569. When the user actuates summary actuator 569, a different, summary, display is generated. In one embodiment, the user can also pan to the right on user interface display 392 to reveal a projects user input mechanism. When the user actuates the projects user input mechanism, the display shows hours billed against various projects for the present timesheet. The view generated when the user actuates the summary actuator is described below with respect to FIG. 2E. The view generated when the user actuates the projects actuator is also described below with respect to FIG. 2E. Other views can be shown as well, and those described are exemplary only.

In one embodiment, the user can also scroll display 392 in the vertical direction. In this way, the user can view prior timesheets as well. Those timesheets correspond to previous time periods for which timesheets have been generated.

By way of example, FIG. 2D-2 shows some of the items that are described above with respect to FIG. 2D-1. However, it can be seen that the user has scrolled the display downward to reveal part of the timesheet that has already been generated for the previous time period. For instance, the display not only shows information for the current time period (as discussed above with respect to FIG. 2D-1) but it also shows some of the information for the previous time period, such as the date range 568, the total number of hours 570, and a plurality of dates, all of which reside in the previous time period, and which are indicated generally by numeral 572.

Both of the displays shown in FIGS. 2D-1 and 2D-2 illustratively include add actuator 393 and submit actuator 395. If the user actuates the add actuator 393, the user can illustratively add a time entry to the displayed timesheet. If the user actuates the submit actuator 395, the user can illustratively submit the displayed timesheet into a workflow, such as for approval, for billing against various projects, etc.

FIG. 2D-3 shows one example of a user interface display (e.g., a create/edit display) 575 that can be generated when the user actuates a user input mechanism that allows the user to add or edit a time entry. For example, in FIG. 2D-1, if the user actuates the user input mechanism 393, user interface display 575 can be generated. Also, if the user actuates one of the fields adjacent a date in the calendar display of FIG. 2D-1, this can indicate that the user wishes to add a time entry on that date as well, and user interface display 575 can be generated in that case as well (with the date filed already filled in).

In the embodiment shown in FIG. 2D-3, user interface display 575 includes a date field 577, a time field 579, a project field 581 and a more details actuator 583. In the embodiment illustrated, fields 577-581 are user actuatable input mechanisms. The fields 577-581 can be actuated by a suitable action, such as a touch gesture, a mouse click, a voice command, etc. When the user actuates one of those fields, a display is generated that allows the user to input information into the corresponding field. For instance, if the user actuates date field 571, then a user input mechanism is displayed that allows the user to input the date. This can be a user input mechanism similar to that described above with respect to FIG. 1F-3, it can be a keypad that allows the user to enter alphanumeric information, or any other desired user input mechanism.

Similarly, when the user actuates the time field 579, the user is able to enter a time, and when the user actuates project field 581, the user can illustratively select from a list of projects, input a new or existing project, etc.

When the user actuates the more details actuator 583, a display is generated that shows additional details that the user can enter or view for the time entry.

User interface display 575 also allows the user to edit an existing time entry. Therefore, when the user selects a time entry (such as from FIG. 2D-1 or 2D-2), the more detailed information corresponding to that time entry is displayed in the create/edit display 575. This allows the user to add, delete, or otherwise modify detail information corresponding to that time entry.

FIG. 2D-4 shows one embodiment of a more detailed display 585 corresponding to the given time entry. It can be seen that additional fields 587, 589 and 591 are shown for the time entry, that can be generated when the user actuates the more details actuator 583. Those shown in FIG. 2D-4 correspond to the category, the activity, and the charge code for the time entry. Although different or additional information and fields can be displayed as well.

Referring again to FIG. 2D-1, assume that the user now actuates the summary user input mechanisms 569. In that case, the display component generates another view of the timesheet, in summary form. FIG. 2E shows one embodiment of a summary user interface display 593. In the embodiment shown, the summary display includes the date range and status for the current timesheet as indicated by numbers 388 and 390, respectively. The summary information shown in FIG. 2E also includes a date indicator 595 followed by each project for which a time entry was made on that date, and the number of hours entered for that project, on that date. This is indicated generally at 597. Of course, the summary view shown in FIG. 2E is exemplary only and different summary information can be generated as well.

FIG. 2E also shows a portion of the projects actuator discussed above with respect to FIG. 2D-1. In the embodiment shown, the project actuator is indicated by numeral 599. When the user actuates the projects actuator 599, a project view is generated that shows the total amount of time billed to each project during the current pay period. Of course other views can be generated and displayed as well.

FIGS. 2F and 2G illustrate two different embodiments of user interface displays 394 and 396, respectively, that can be generated by timesheet capture component 304 to allow a user to enter time. Display 394 includes an “add time entry” actuator that navigates the user to a time entry page where the user can enter the number of hours and a description, and any other desired information. The “view time” actuator allows the user to view time entries on a timesheet or timecard. The “add expense” actuator allows the user to add an expense.

User interface display 396 in FIG. 2G shows one embodiment of a user interface display that is generated when the user actuates the “add time entry” actuator in FIG. 2F. It can be seen that the user can enter a date, a time, and a legal entity corresponding to the time entry. The user can also enter a project name and a category, and can also define additional information, such as the activity, etc. In one embodiment, the user interface displays 394 and 396 are actuated using touch gestures. Therefore, the user can select one of the fields in display 396 and enter the information from a soft keypad, or in other ways.

FIG. 3 shows a more detailed block diagram of one embodiment of approval component 126. Approval component 126 illustratively includes aggregator component 400, view generator 402, sort component 404 and drill component 406. Aggregator component 400 illustratively aggregates all approvals for user 110, from business applications 120 or other components, items or applications in business system 102. View generator 402 illustratively generates various views of those approvals and sort component 404 allows user 110 to sort the displayed approvals according to various sort criteria. Drill component 406 allows the user to actuate any given approval and be presented with more detailed, contextual information corresponding to that approval so that the user can approve or reject the specific approval.

FIG. 3A is a flow diagram illustrating one embodiment of the overall operation of approval component 126. Aggregator component 407 illustratively aggregates the approvals for user 110 intermittently or continuously. This is indicated by block 407. Then, as with the other components discussed above, user 110 accesses business system 102 and launches approval component 126 (such as by actuating user input mechanism 223 in FIG. 1B-1, or otherwise). This is indicated by block 408.

In response, approval component 126 illustratively generates a landing page display. This is indicated by block 410. The landing page display is illustratively a panoramic display 412 that is horizontally scrollable to present the user with a variety of different types of information about the approvals. For instance, the landing page display can show the number of aggregated, pending approvals 414. The landing page display can also show visual representations (such as icons or tiles, etc.) corresponding to each approval for this user, grouped into groups. The groups can be the type of approval, the submitter who is submitting the item for approval, the date of submission of the approval, or other group criteria. This is indicated by block 416. The landing page display can also include other information 418 as well.

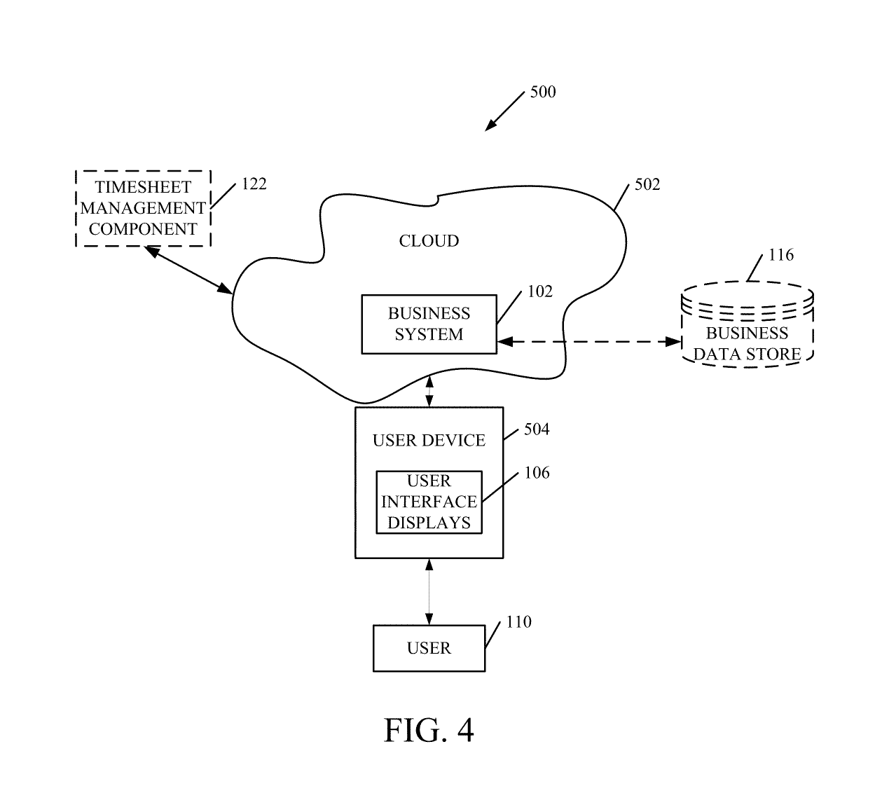

FIG. 3B shows one embodiment of a landing page display 420. Landing page display 420 illustratively includes a pending approvals indicator 422 that shows the number of pending approvals for user 110. The display 420 is illustratively a panoramic display in that it can be horizontally scrollable in the directions indicated by arrow 424. As the user scrolls to the right, the user illustratively views additional information corresponding to his or her approvals. For instance, FIG. 3C shows one embodiment of user interface display 420 in which user 110 has scrolled to the right. It can be seen that the approvals are grouped into groups 421, 423 and 425 and can each be represented by an icon or tile 426. In the embodiment shown in FIG. 3C, group 421 is an expense reports group that contains tiles or icons 426, each of which represents an expense report that has been submitted for approval by user 110. Group 423 is an invoice proposals group that includes tiles or icons 426, each of which corresponds to an invoice proposal that has been submitted to user 110 for approval. Group 425 is a timesheets group that includes icons or tiles 426, each of which represents a timesheet that has been submitted for approval by user 110. The face of the icon or tile can include a variety of different types of information, such as an indication of who submitted the approval, the type of approval, and other descriptive information about the approval. For instance, FIG. 4C shows an enlarged version of an icon or tile 427 that represents an expense report under expense report group 421. It can be seen that tile 427 illustratively includes an image 429 and a name 431. The image 429 and name 431 are both illustratively indicative of the person who submitted the expense report. Tile 427 can also include an amount and currency indicator 433 that represents the total amount (in the specified currency) for the expense report. Tile 427 can also illustratively include a description 435 that describes the nature of the expense report.

It will be noted that the tiles or icons can be different, based upon the underlying item that they represent. For instance, FIG. 3C also shows one embodiment of another tile or icon 437 that represents a timesheet. Again, tile or icon 437 can include an image 439 and a name 441, both of which represent the person who submitted the timesheet. However, instead of a currency amount, tile or icon 437 can include a number of hours indicator 443 that shows the number of hours represented by the timesheet, and a description 445 that describes the nature of the time entries on the timesheet.

In the embodiment shown in FIG. 3C, user interface display 420 also illustratively includes a sort criteria selector 447. Sort criteria selector 447 is a user input mechanism (such as a dropdown menu) that allows user 110 to sort the pending approvals based on a variety of different criteria. When the user selects different criteria using sort criteria selector 447, the tiles or icons 426 representing the different approvals will be grouped into other groups, based upon the newly selected sort criteria. In the embodiment shown in FIG. 3C, it can be seen that the user has illustratively selected that the approvals be sorted into groups based on the type of approval that they represent. Therefore, the approvals are sorted into the expense report group 421, the invoice proposal group 423 and the timesheet group 425.

Referring again to the flow diagram of FIG. 3A, after the landing page is displayed, user 110 illustratively interacts with landing page 420. This is indicated by block 430 in FIG. 3A. The user can illustratively change the sort criteria as indicated by block 432. The user can actuate an icon or tile 426 as indicated by block 434, or the user can interact with page 420 in other ways as indicated by block 436.

Approval component 126 then performs one or more actions based upon the user interaction with the landing page. This is indicated by block 438. In one embodiment, sort component 404 illustratively re-sorts the icons or tiles 426 based on new sort criteria selected by the user. This is indicated by block 440. Drill component 406 can illustratively navigate the user to more detailed information corresponding to a given approval, if the user actuates one of the tiles or icons 426. Presenting additional contextual information along with the approve/reject mechanisms and further drill mechanisms is indicated by block 442 in FIG. 3A. Approval component 126 can perform other actions as well, based on other interactions with landing page 420. This is indicated by block 444. Some of these interactions are discussed in more detail below with respect to FIGS. 3D-3M. If a pending approval is approved, the corresponding application or workflow is notified so corresponding workflows can continue. This is indicated by block 439.

FIG. 3D shows another embodiment of user interface display 420, and similar items are similarly numbered to those shown in FIG. 3C. However, it can be seen that the user has now actuated the sort type mechanism 447. This illustratively causes sort component 404 (shown in FIG. 3) to generate a display of a dropdown menu that allows the user to sort the pending approvals by type 449, by submitter 451, by date 453 or based on other criteria 455.

FIG. 3E shows another embodiment of a user interface display 457. Some items are similar to those shown in FIG. 3D, and they are similarly numbered. However, it can be seen that the user has now selected that the pending approvals be sorted by submitter. Therefore, the pending approvals are sorted into groups 459 (corresponding to approvals submitted by Jane Doe), 461 (corresponding to approvals submitted by John Q.), 463 (corresponding to approvals submitted by Jim P.), and group 465 (corresponding to approvals submitted by Jane Deer). It can be seen that each of the tiles or icons 426 has now been resorted into the appropriate group. Therefore, different types of pending approvals can be grouped into the same group, as long as they were submitted by the same submitter. This can be seen in FIG. 3E, for example, by the fact that group 459 corresponds to two different types of pending approvals, two expense report approvals and one timesheet approval, but both types have been submitted by Jane Doe. Similarly, group 461 includes an expense report approval and an invoice proposal approval in the same group, because they were both submitted by John Q.

FIGS. 3D and 3E also show an approvals state selector 467. Selector 467 allows the user to select the types of approvals that are displayed based upon their state. For instance, if the user actuates selector 467, a dropdown menu (or another suitable user input mechanism) can be provided that allows the user to choose to display approvals that are pending, that have already been approved, that have been declined, or approvals in another state.

As can be seen in FIGS. 3B-3E, each approval that is submitted for being approved by user 110 is represented by an icon or tile 426 that can be actuated by the user. When the icon or tile is actuated by user 110, drill component 406 (again shown in FIG. 3) illustratively generates a display that shows more contextual information corresponding to that approval so that the user can actually approve or reject that pending approval. FIG. 3F shows one embodiment of an approval display 469 that can be generated when the user actuates one of the icons or tiles 426 corresponding to an approval. FIG. 3F shows that approval display 469 illustratively includes submitter information 471 that is indicative of the person that submitted the approval. Display 469 also illustratively includes a view selector 473 that allows user 110 to change the type of view of the approval display. Contextual information 475 illustratively includes a variety of different types of information, depending upon the type of approval that is represented by display 469, so that user 110 can illustratively approve or reject the submitted approval. Approve/reject mechanisms 477 illustratively allow the user to interact with display 469 in order to approve or reject a pending approval.

FIG. 3G shows a more detailed embodiment of an approval display 446 that can be generated when the user has actuated one of tiles or icons 426. In that case, drill component 406 has presented more detailed information about the given approval. It can be seen that the left side of display 446 includes an approval summary portion 448 that shows summary information regarding the approval, along with approve/reject mechanisms 477. In the embodiment illustrated, the approval is for a timesheet that has been entered by an employee John Doe.

Summary portion 448 illustratively includes an image, name and title for the submitter, all represented by submitter information 471. The summary portion 448 can also include a plurality of different communication buttons 481, each of which allow user 110 to initiate communication with the submitter using a different type of communication (such as using a messaging system, electronic mail, telephone, etc.). Summary portion 448 can also include information that vary, based upon the type of approval. For instance, since the approval represented by display 446 is a timesheet, summary portion 448 can include an hours display 483 that represents the total number of hours on the timesheet. Summary portion 448 can also illustratively include a number of projects section 485 that represents the number of projects to which time has been billed on the present timesheet. Summary portion 448 can also illustratively include a historical section 487 that represents timesheets submitted by the present submitter during previous time periods. This can be useful, for instance, to determine whether anything appearing on the present timesheet is unusual.

Display 446 also includes overview actuator 452, time details actuator 454, time summary actuator 456 and project impact actuator 458. When the user actuates any of actuators 452-458, the view generator 402 generates an appropriate view.

FIG. 3G shows that, the user has actuated overview actuator 452. Therefore, view generator 402 illustratively generates an overview with overview information. The overview information can include, for instance, a description of the nature of the pending approval (such as what to look for in deciding whether to approve or reject the pending approval), the date submitted, the due date, the timesheet number, employee, and total time. These are examples only.

FIG. 3H shows that the user has actuated the time details actuator 454. In that case, details corresponding to the timesheet submitted for approval are shown in tabular (or other) form. In the embodiment shown in FIG. 3H, the display includes details information for the timesheet identified in the header of display 446 (e.g., for the timesheet dated March 11-March 17). It can be seen in the embodiment of FIG. 3H that the details information includes the date that a time entry was made, the project for which the time entry was made, the amount of time entered, and the category for the activity performed during that time entry. In addition, a details actuator 459 allows the user to see even more details for a given time entry.

FIG. 3I shows another embodiment of a user interface display 451. Display 451 includes some similar items to those shown in FIG. 3G, and they are similarly numbered. FIG. 3I shows that the user has actuated the time summary actuator 456. In that case, view generator 402 generates a view showing various summary information for the time entries on the corresponding timesheet (identified in the header). In the embodiment shown in FIG. 3I, summary information includes a first chart 453 and a second chart 455. The first chart is a pie chart 457 that shows the time entries on the corresponding timesheet, in proportion to the project against which they are entered. Chart 457 shows that two-thirds of the time was entered against a first project and one-third of the time was entered against a second project. The chart 453 also includes a key 459 that identifies (such as by color coding, shading, etc.) the various projects represented in pie chart 457.

Chart display 455 includes a second pie chart 461 that identifies the time entries in the corresponding timesheet plotted against the particular activity for which they were entered. Key 463 identifies (such as by color coding, shading, etc.) the particular activities represented in pie chart 461. Pie chart 461 shows that 55 percent of the time entered on the corresponding timesheet was entered for a first activity, 35 percent was entered for a second activity, and 10 percent was entered for a third activity. Of course, the summary information shown in FIG. 3I is exemplary only and a wide variety of different or additional summary information can be generated as well, when the user actuates time summary actuator 456.

FIG. 3J shows another user interface display 465. User interface display 465 is similar to display 451 shown in FIG. 3I, and similar items are similarly numbered. It can be seen in FIG. 3J that the user has actuated the project impact actuator 458. Thus, view generator 402 generates a view showing the impact that the corresponding timesheet has on various aspects of the entire project. In the example shown in FIG. 3J, the project impact display includes a first impact display 467 and a second impact display 469. Display 467 includes a bar chart 471 that shows a first indicator 473 identifying the total time budget for the project, and a second indicator 475 that shows the impact of the current timesheet on the overall budget. It can be seen in impact display 467 that the current timesheet puts the project over budget, because indicator 475 lies to the right of indicator 473.

Impact display 469 shows the impact of the corresponding timesheet on the current billing cycle. Indicator 477 shows the total number of hours budgeted for this billing cycle and indicator 479 identifies the impact of the current timesheet on the time budgeted for the current cycle. It can be seen that the current timesheet puts the time for this cycle over budget. It will be noted, of course, that the project impact information shown in FIG. 3J is exemplary only and a wide variety of different or additional impact information could be displayed as well.

From the panoramic landing page 420 in FIG. 3D, assume that the user has now actuated one of the icons 426 that represent an expense report that has been submitted for approval. An approval display, such as the one shown in FIG. 3F, will be displayed. The approval display will include information identifying the submitter, optionally a view selector 473 and contextual information 475 that allows the user to approve or reject the pending approval using approval/reject mechanisms 477. FIG. 3K shows one embodiment of a user interface display 481 that is generated when the user actuates an icon 426 corresponding to an expense report approval.

It can be seen that display 481 illustratively includes a header portion 483 that identifies the approval as an expense report and gives a brief description or title for the expense report, in this case “Team Retreat”. The display 481 also includes the submitter information shown generally at 471 which includes similar information to that shown in FIG. 3G. However, because the present display 481 represents an expense report, it also includes a total dollars display 485 that identifies the total amount and denomination (in this case dollars) entered on the expense report. It illustratively includes a previous expenses display 487 that may summarize previous expenses submitted by the submitter. It also includes approve/reject mechanisms 450.

Display 481 includes view selectors or actuators that include an overview actuator 489, an expenses actuator 491 and a totals actuator 493. When the user actuates overview actuator 489, a view is generated that shows overview information for the underlying expense report. When the user actuates totals actuator 493, a view is generated that shows overall totals for the underlying expense report. In the embodiment shown in FIG. 3K, the user has actuated expenses actuator 491. This provides more detailed information 495 identifying the expenses on the expense report. For instance, the detail information 495 can include a total expense line item, a category for which that line item was entered, a date on which the entry was made, a merchant to whom the expense was paid, a project against which the expense can be billed, etc. It should be noted, of course, that the information shown in FIG. 3K is exemplary only and a wide variety of different or additional information can be displayed as well.

In another embodiment, approvals can be reviewed and either approved or rejected using different mechanisms as well. For instance, where a user has access to electronic mail, the present system allows the user to receive and either approve or reject pending approvals through the electronic mail system. FIG. 3L shows one embodiment of a user interface display 501 illustrating this.

Display 501 is a display screen for an exemplary electronic mail account for user 110. In the present embodiment, aggregator component 400 (in approval component 126) aggregates the pending approvals for user 110 and generates electronic mail messages for each pending approval. Display 501 shows that the user has actuated the “inbox” folder in folder section 503 so that pane 505 shows an inbox display. It can be seen that the user has highlighted a “business system approval” email 507 on inbox pane 505. In that case, details pane 509 displays detailed information 511 that describes the approval represented by electronic mail message 507. The detail pane 509 also includes approve/reject actuators 513 which, when actuated by user 110, serve to automatically approve or reject the pending approval within business system 102. In one embodiment, approval component 126 receives the approval as an electronic mail message and automatically converts it to an approval (or rejection) of the pending approval within business system 102.

In any of the embodiments, if the user actuates one of the approve or reject actuators 450 or 477 (from previous figures), approval component 126 approves the selected approval within business system 120 and view generator 402 illustratively generates a confirmation display that allows the user to confirm his or her choice. FIG. 3M shows one embodiment of a confirmation display 460 that allows the user to confirm a choice of approving the underlying timesheet. If the user changes his or her mind, or approves the timesheet in error, the user can cancel the approval choice and return to a previous display such as the one shown in FIG. 3H.

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that business system 102 is located in cloud 502 (which can be public, private, or a combination where portions are public while others are private). Therefore, user 110 uses a user device 504 to access those systems through cloud 502.

FIG. 4 also depicts another embodiment of a cloud architecture. FIG. 4 shows that it is also contemplated that some elements of business system 102 are disposed in cloud 502 while others are not. By way of example, data store 116 can be disposed outside of cloud 502, and accessed through cloud 502. In another embodiment, timesheet management component 122 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

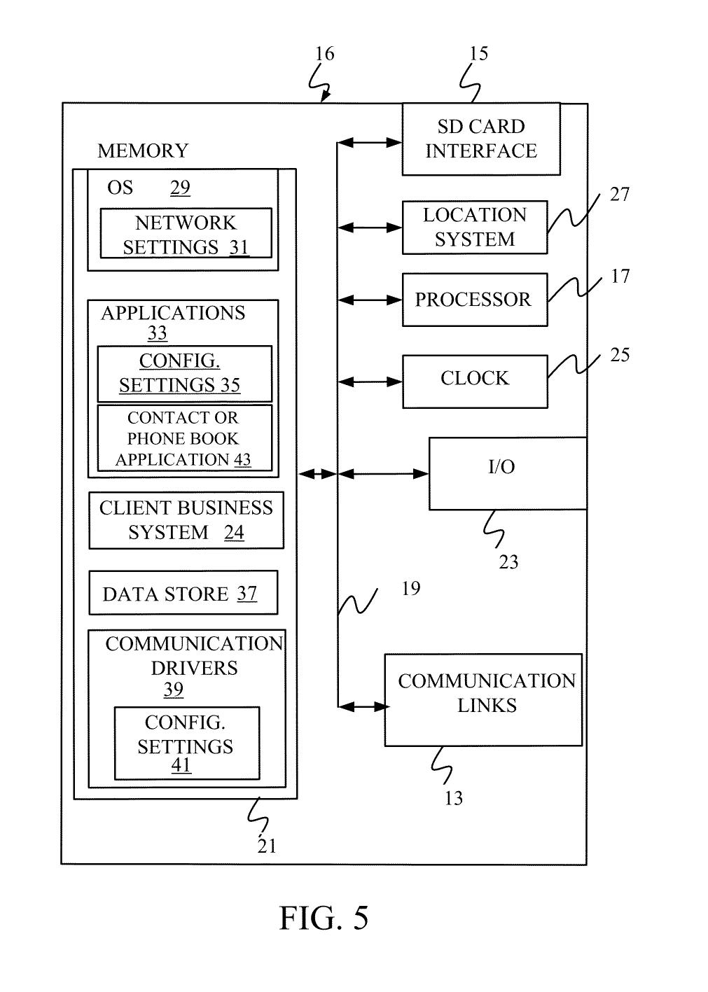

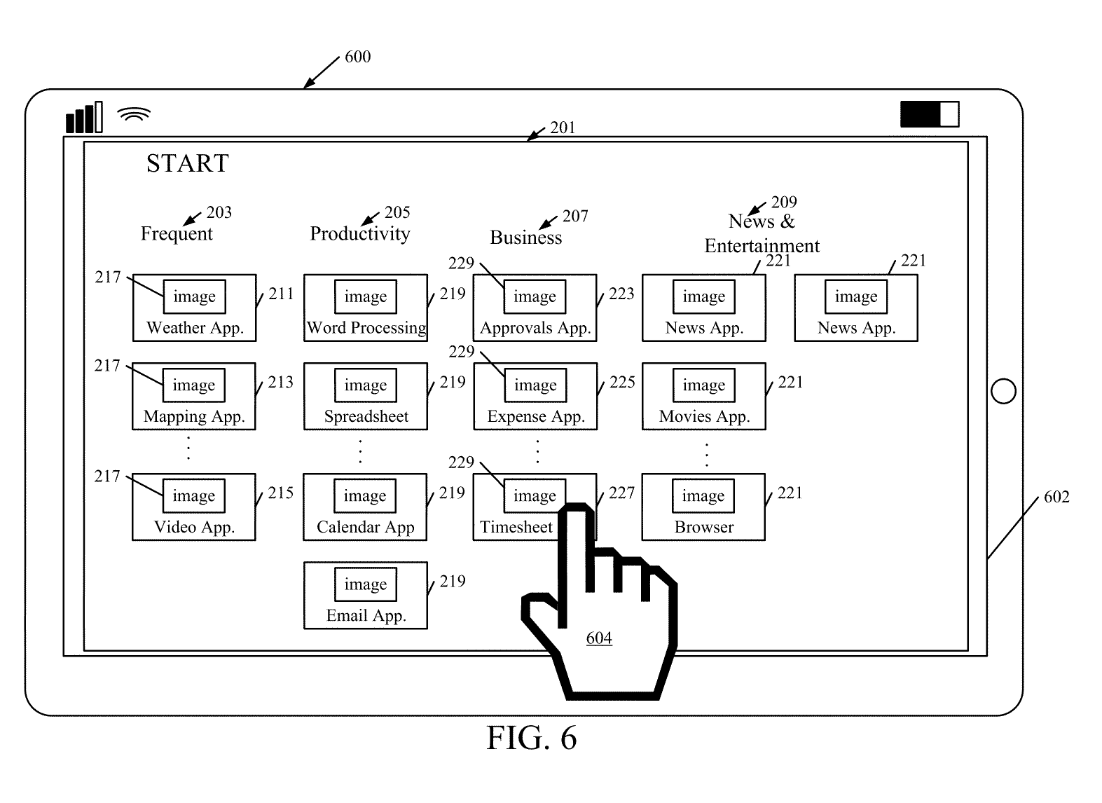

FIG. 5 is a simplified block diagram of one illustrative embodiment of a handheld or mobile computing device that can be used as a user's or client's hand held device 16, in which the present system (or parts of it) can be deployed. FIGS. 6-10 are examples of handheld or mobile devices.

FIG. 5 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like companion applications) are received on a removable Secure Digital (SD) card that is connected to a SD card interface 15. SD card interface 15 and communication links 13 communicate with a processor 17 (which can also embody processors 114 or 136 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display from FIG. 1B-1 displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

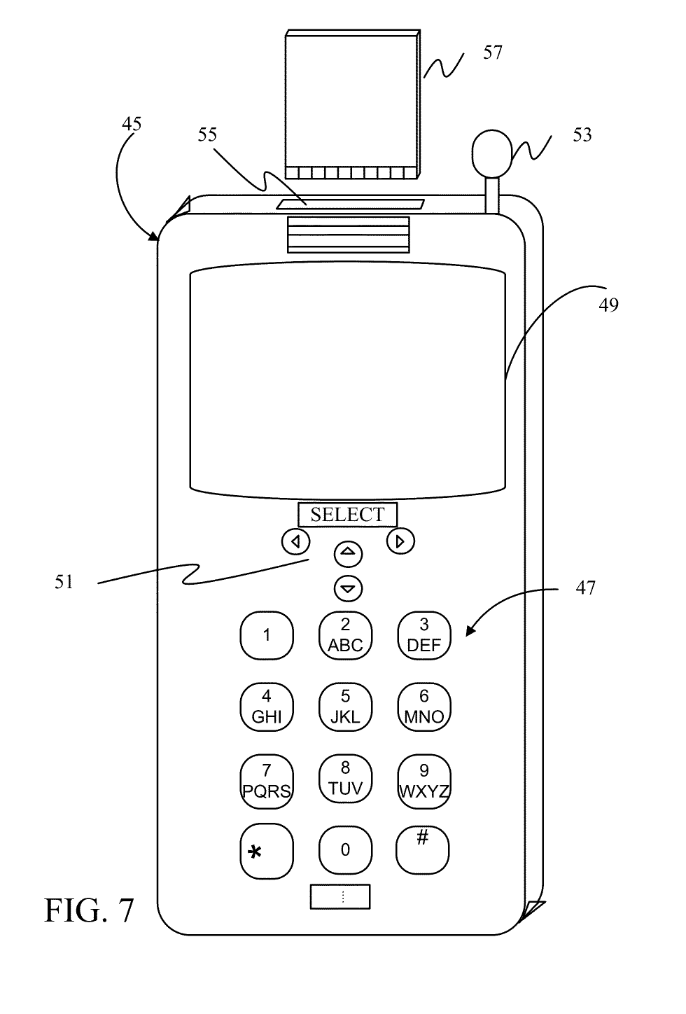

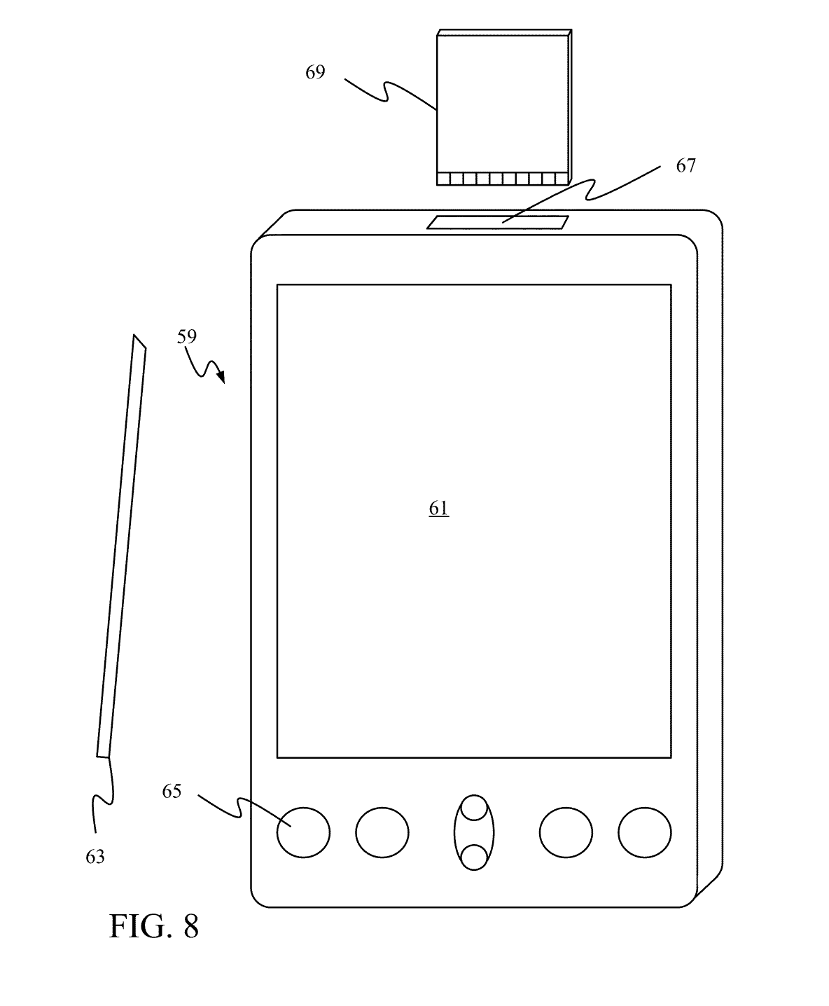

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

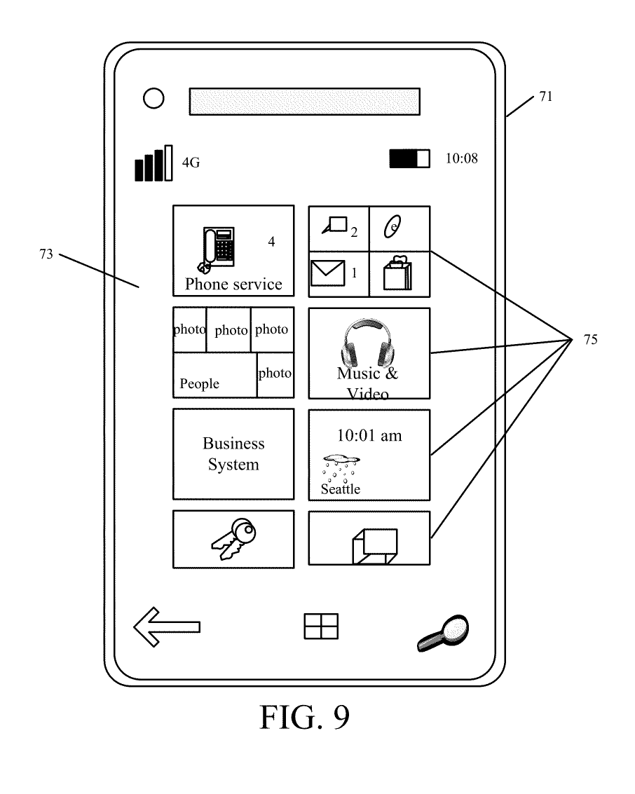

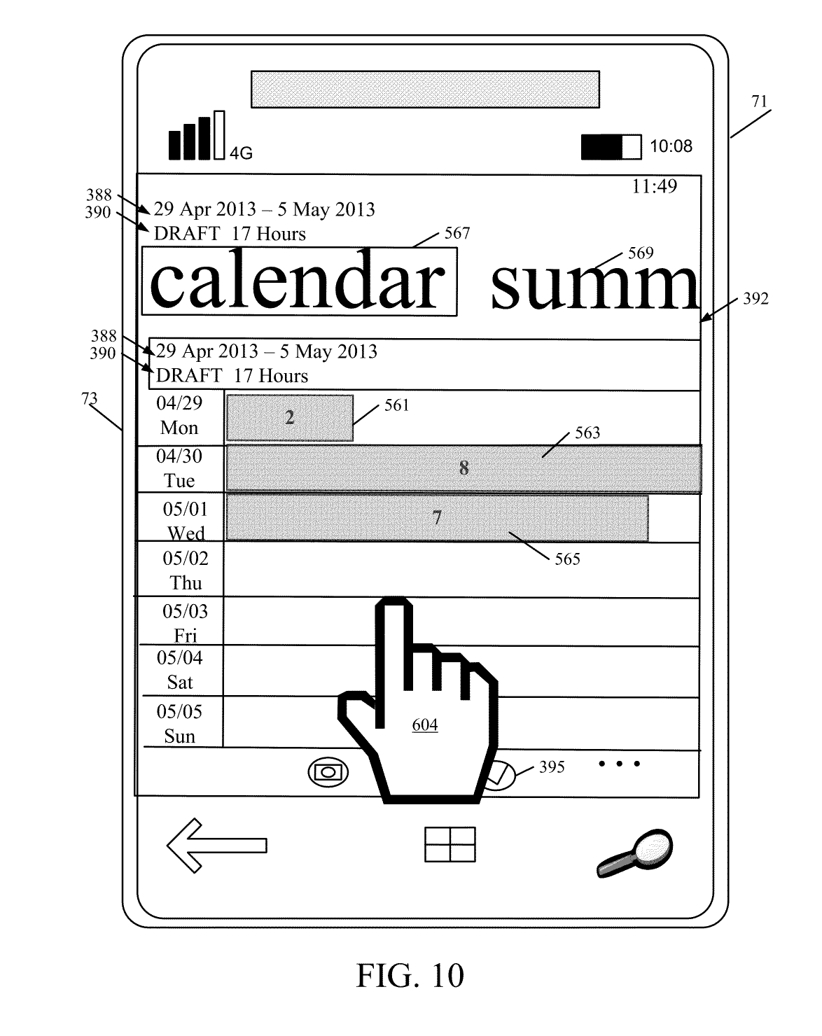

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 10 shows smart phone 71 with the display from FIG. 2D-1 displayed thereon.

Note that other forms of the devices 16 are possible.

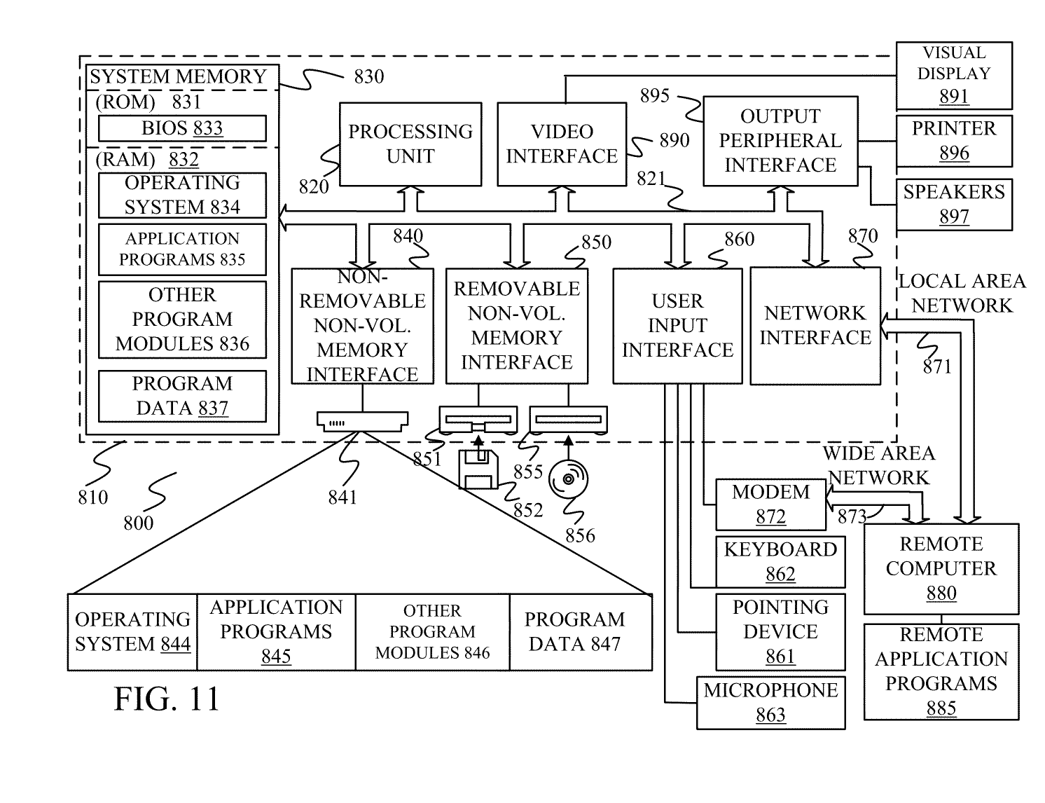

FIG. 11 is one embodiment of a computing environment in which architecture 100, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processor 114 or 136), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A mobile device, comprising:
a display;
a processor having timing circuitry, the processor being coupled to the display;
a wireless communication interface coupled to the processor and configured to communicate wirelessly with a remote device;
memory circuitry coupled to the processor, the memory circuitry storing instructions, which, when executed by the processor provide a timesheet management application;
a touch sensor configured to sense physical user input as a touch gesture; and
the timesheet management application being configured to generate a panoramic main timesheet page that receives user input in the form of a touch gesture indicative of creating a new time entry or reviewing an existing time entry,
wherein the processor is configured to receive the touch gesture user input and responsively provide a user interface having functionality of one of new time entry and reviewing an existing time entry and to change data in the remote device through the wireless communication interface as a result of user interaction with the user interface.

2. The mobile device of claim 1, wherein the user interface provides functionality for reviewing an existing time entry.

3. The mobile device of claim 2, wherein the main timesheet page provides existing timesheet review by project.

4. The mobile device of claim 3, wherein timesheet information is color-coded by project.

5. The mobile device of claim 2. wherein the main timesheet page provides existing timesheet review by time.

6. The mobile device of claim 5, wherein the time is a current period view.

7. The mobile device of claim 5, wherein the time is a previous period.

8. The mobile device of claim 7, wherein the previous period is displayed on a calendar view.

9. The mobile device of claim 1, wherein the mobile device is a phone.

10. The mobile device of claim 2, wherein the processor is configured to detect a touch gesture using the touch sensor and responsively pan the display.

11. The mobile device of claim 1, wherein the memory contains an additional application, which, when executed by the processor, provides one of expense report maintenance functionality and business document approval functionality.

12. The mobile device of claim 1, wherein the user interface provides functionality for new time entry, and wherein the user interface includes an edit pane that slides out to receive details for a new time entry.

13. The mobile device of claim 12, wherein the details include an amount of time, a date, a project, a category, an activity code, and a note.

14. A mobile device, comprising:
a processor having timing circuitry;
memory circuitry coupled to the processor, the memory circuitry storing instructions, which, when executed by the processor provide a timesheet management application;
a speech recognition component; and
the timesheet management application being configured to generate a main timesheet page configured to receive user input in the form of a speech and to create a new time entry in response to the user input,
wherein processor is configured to user receive further user input providing details of a new time entry in the form of speech.

15. The mobile device of claim 14, wherein the memory contains an additional application, which, when executed by the processor, provides one of expense report maintenance functionality and business document approval functionality.

16. The mobile device of claim 14, wherein the details include an amount of time, a date, a project, a category, an activity code, and a note.

17. The mobile device of claim 14, and further comprising a wireless communication interface configured to communicate wirelessly with a remote device to update a timesheet record based on the new time entry.

18. The mobile device of claim 14, wherein the mobile device is a phone.

19. The mobile device of claim 14, and further comprising a display coupled to the processor and configured to display a chart using information from the timesheet management application.

20. A method of receiving timesheet information with a mobile device, the method comprising:
generating a panoramic landing page on a display of the mobile device, wherein the panoramic landing page is scrollable at least horizontally;
displaying a plurality of timesheets on the panoramic landing page wherein the plurality of timesheets are groups and each group includes an icon that is currently in the status represented by that group;
receiving user input in the form of a touch gesture on the panoramic landing page; and
responsively performing an action based on the touch gesture.
